(19) United States
(12) Patent Application Publication
(10) Pub. No.: US 2010/0037056 A1
(43) Pub. Date: Feb. 11, 2010

(54) METHOD TO SUPPORT PRIVACY PRESERVING SECURE DATA MANAGEMENT IN ARCHIVAL SYSTEMS

(76) Inventors: Benjamin D. Follis, Redwood City, CA (US); William A. Maniatty, Niskayuna, NY (US)

Correspondence Address: HOFFMAN WARNICK LLC, 75 STATE STREET, 14TH FLOOR, ALBANY, NY, 12207, US

(21) Appl. No.: 12/537,343

(22) Filed: Aug. 7, 2009

Related U.S. Application Data
(60) Provisional application No. 61/087,032, filed on Aug. 7, 2008.

(51) Int. Cl. H04L 9/32; G06F 17/30

(52) U.S. Cl. 713/171; 707/202; 707/204; 713/150; 713/168; 713/189; 707/E17.007; 707/E17.005

(57) ABSTRACT

An infrastructure for archiving data among a client, a broker, and a plurality of archives, wherein the client comprises: a backup agent configured to fragment and erasure encode the data to create a set of erasure encoded data fragments; a communications agent configured to communicate the erasure encoded data fragments to the broker, issue a challenge for a challenge/response protocol to the broker, and to request data from the archives; and a restore agent configured to combine the data fragments obtained from the broker upon a data restore request.

### CROSS REFERENCE TO RELATED APPLICATIONS

This application claims priority to U.S. Provisional Patent Ser. No. 61/087,032, filed Aug. 7, 2008, the contents of which is hereby incorporated by reference.

### TECHNICAL FIELD

This disclosure relates generally to archiving data. More specifically, the disclosure relates to secure data archiving between a client, broker, and a plurality of archives with minimal data loss.

### BACKGROUND OF THE INVENTION

In this era of highly connected and wireless computing, important data is still subject to improper disclosure, forgery, corruption, and erasure. It is well known that archival copies of confidential information can expose large volumes of personal data to disclosure. Furthermore, it is not sufficient to rely on single repositories for data storage. Additionally, traditional methods guarding against insider threats can deny legitimate access to critical data or expose sensitive archived data to disclosure, corruption or deletion.

A new approach to electronic data archival is needed, that allows ease of access, but is capable of supporting disaster recovery operations, data retention policies, and ensuring compliance with privacy and retention regulations.

### SUMMARY OF THE INVENTION

According to one aspect of the present invention, an infrastructure is provided for archiving data among a client, a broker, and a plurality of archives, wherein the client comprises: a backup agent configured to fragment and erasure encode the data to create a set of erasure encoded data fragments; a communications agent configured to communicate the erasure encoded data fragments to the broker, issue a challenge for a challenge/response protocol to the broker, and to request data from the archives; and a restore agent configured to combine the data fragments obtained from the broker upon a data restore request.

According to another aspect of the invention, a method is provided for archiving data among a client, a broker, and a plurality of archives, comprising: fragmenting and erasure encoding the data at a client to create a set of erasure encoded data fragments; communicating the set of erasure encoded data fragments to the broker; and storing the set of erasure encoded data fragments in a plurality of archives.

According to another aspect of the invention, a computer readable storage medium is provided having a computer program product stored thereon for archiving data among a client, a broker, and a plurality of archives, which when executed by a computer system comprises: program code configured to fragment and erasure encode the data to create a set of erasure encoded data fragments; program code configured to communicate the erasure encoded data fragments to the broker, issue a challenge for a challenge/response protocol to the broker, and to request data from the archives; and program code configured to restored the data by combining the data fragments obtained from a broker upon a data restore request.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an infrastructure according to one aspect of the invention.

FIG. 2 shows a computer system according to one aspect of the invention.

FIG. 3 shows a flowchart of a data archiving process according to an aspect of the invention.

FIG. 4 shows a typical point-to-point service protocol.

FIG. 5 shows a trusted witness proxy acting in slow mode.

FIG. 6 shows a trusted witness proxy acting in fast mode.

FIG. 7 shows a trusted witness disputation protocol.

FIG. 8 shows a server side protocol architecture.

FIG. 9 shows a broker's challenge/response protocol.

FIG. 10 shows a DFA for the archive's side of the single archive storage reservation protocol.

FIG. 11 shows a DFA for archive's side of the single archive storage reservation protocol.

FIG. 12 shows a DFA for Broker in Single Fragment Distribution.

FIG. 13 shows an Archive Set Establishment Protocol example.

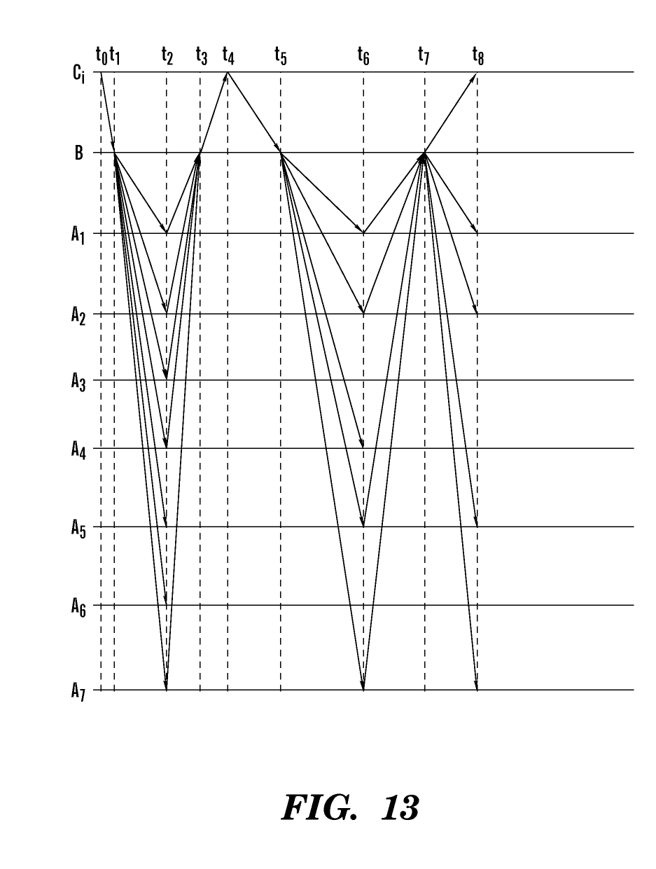

FIG. 14 shows a DFA for Broker's Challenge-Response Protocol.

FIG. 15 shows a DFA for Archive's Challenge-Response Protocol.

FIG. 16 shows a DFA for Broker Recovery of d_{i,j} where NF represents the Needs Fragments predicate, NF=(|RetrievedFragmentSet|<m_{i,j}) and FA represents the Fragments Available predicate (meaning enough fragments can be retrieved), FA=(NonEmptyMapCount(FA_{i,j})≧m_{i,j}).

FIG. 17 shows a Broker DFA for the Restore Protocol, note that Appl:OK means the retrieval protocol for di;j succeeded, message numbers correspond to their stage in the protocol.

FIG. 18 shows a timeline of integrity scan to backup.

FIG. 19 shows a streaming backup with computation of message digests (e.g. MD5) and statistics.

FIG. 20 shows a verifiable restore from removable media (or in this case from a remote archive).

FIG. 21 shows an architecture of an archival system using a distributed broker system.

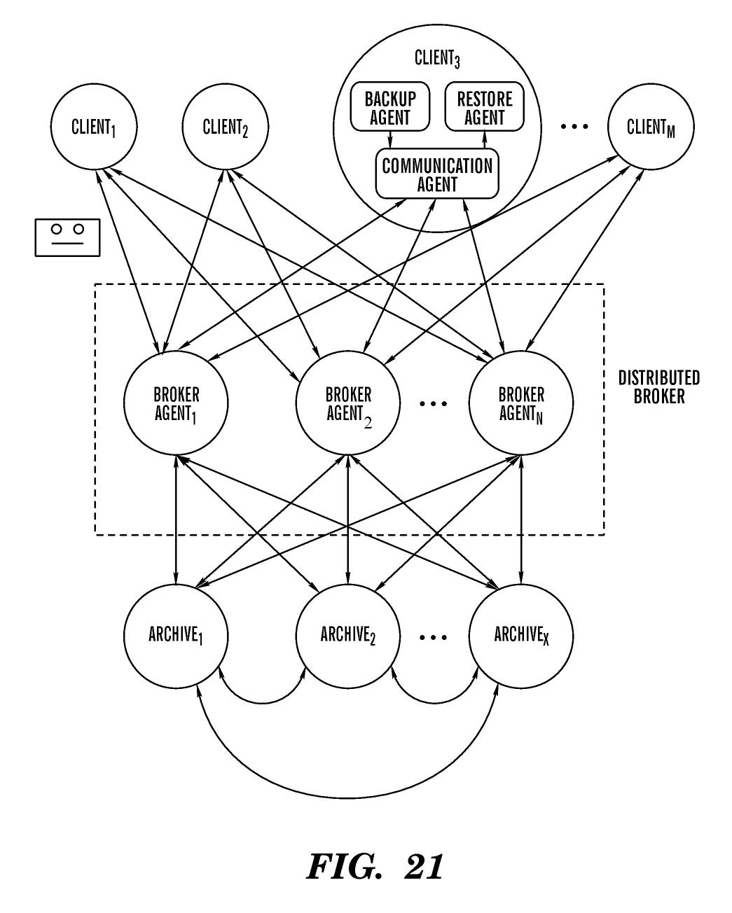

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

The present invention provides an infrastructure for allowing a client to archive data among a plurality of archives using a broker. The client may, for example, be run by a business that regularly needs to archive data in a secure manner.

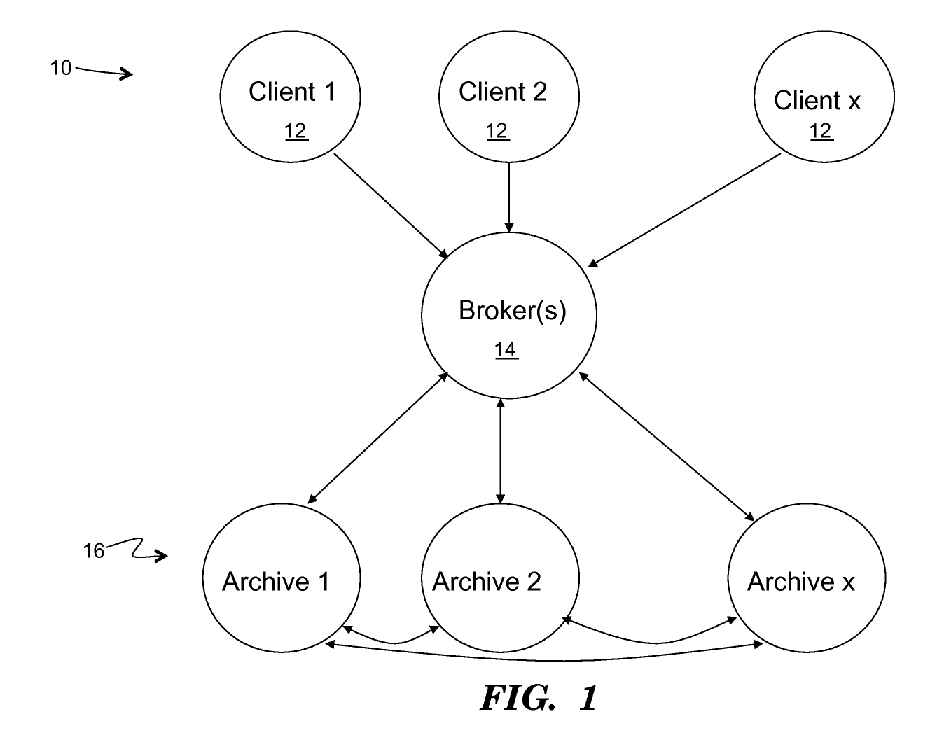

As depicted in FIG. 1, a typical infrastructure 10 may include a client 12 or a plurality of clients 12 in communication with a broker 14. Client 12 sends data to be archived to broker 14 by any now known or later developed means, including over a network, WAN, LAN or internet connection. The data may also comprise cassettes or DVDs of information as well. Broker 14 is in communication with a plurality of archives 16. The broker 14 sends the data, in one embodiment as data fragments, to the plurality of archives 16 for archiving. Each of the plurality of archives 16 may be in communication with one another. Each archive 16 may receive some subset of fragments, which can be restored as a complete data set at the client 12, on demand from the client 12.

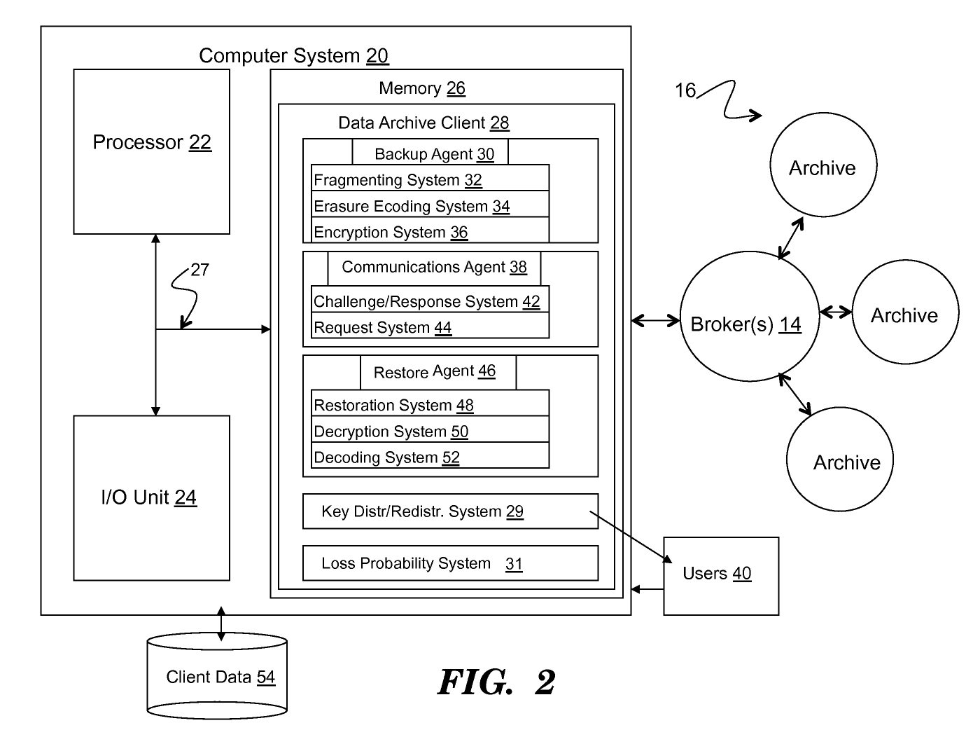

Illustrated in FIG. 2 is a computer system 20 according to an embodiment of the present invention. Shown within computer system 20 are a processor 22 and an I/O Unit 24, each of which may be any now known or later developed device capable of carrying out the basic functions as understood in the art. Within the memory 26 is a data archive client 28 responsible for archiving client data 54. The data archive client 28 may comprise a backup agent 30, a communication agent 38, and a restore agent 36. The computer system 20 is shown in communication with the broker 14, which is subsequently in communication with a plurality of archives 16. The data archive client 28 will be described in more detail below, as well as the general infrastructure.

In an embodiment of the invention, a backup agent 30 is configured to fragment, compress, encrypt, and erasure encode the data. Backup Agent 30 is capable of processing client data 54, e.g., a data file, a set of data files or any type of data which needs to be archived. Backup agent 30 may be configured to perform archiving functions at predetermined times, on demand by an end user, etc. When an archive request is received, the data is first split into fragments by fragmenting system 32. For example, a 1 mb file may be split into 10 equal fragments. Next, erasure encoding system 34 erasure encodes each fragment. The erasure encoding produces check fragments, which are interchangeable and contain data to allow data recovery in the case of lost or corrupted portions of the data. Optionally, encryption system 36 may also encrypt the data for added security. The data may be compressed as well for reasons well known in the art, which would typically be accomplished using fragmenting system 32. The data fragments and check fragments are combined and sent to the communications agent 38.

Communications agent 38 is configured to communicate the data fragments, including the check fragments, to broker 14. Using this method, broker 14 never sees the data as a whole, as the communications agent 38 and broker 14 only see the fragmented, and optionally encrypted, data. Once the data is sent to broker 14, the broker 14 is responsible for allocating the data fragments amongst the plurality of archives 16. When the request system 44 requests the data from broker 14, the retrieved data fragments are sent to the restore agent 36. Communications agent 38 may also include challenge/response system 42 to issue a challenge for a challenge/response protocol to broker 14. In general, the challenge/response system 42 may request a broker 14 to communicate with the plurality of archives 16 in order to answer a trivial question about the data stored. For example, challenge/response system 42 may ask the broker 14 the data value at line 50 of page 29. In a further embodiment, broker 14 may also issue challenge/response questions to the plurality of archives 16 as well. Accordingly, challenge/response system 42 allows client 12 to ensure the erasure encoded data fragments are still stored and not corrupted. The challenge/response protocol will be described with more detail below as it is also used for proactive repair of the erasure encoded data fragments.

Restore agent 46 is configured to combine the data fragments which are retrieved from broker 14 following a request from request system 44. Restoration system 48 is utilized in combining the data fragments received. Restore agent 46 may also include decoding system 52 to decode any extra security encoding carried out on the archived data, as well as in the sense of interpreting the erasure encoding. Restore agent 46 may also include decryption system 50 in cases using encryption of the data. If data was compressed, restoration system 48 may be utilized to decompress the data. At this point, restore agent 46 restores the original data.

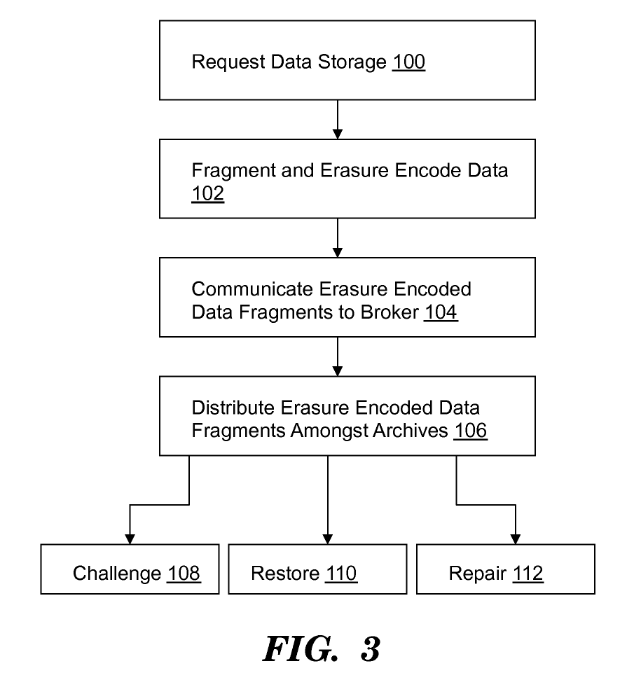

FIG. 3 depicts a typical flow chart detailing the steps described in the system above. In a typical archiving method, client 12 requests data storage at step 100. At step 102 fragmenting system 32 and erasure encoding system 44 fragment and erasure encode the data. At step 104 communications agent 38 sends the erasure encoded data fragments to broker 14. Broker 14 then distributes the erasure encoded fragments among the plurality of archives 16 at step 106. After distribution, challenge/response system 42 may issue a challenge at step 108. At step 110 request system 44 may request the data for restore agent 46 to restore. At step 112, if any errors, corruptions, or any other issues are detected, for instance a failed response to a challenge/response question, data may be repaired by any means described herein.

In many embodiments, this system employs a number of security functions that reduce data loss, reduce the cost of archiving and restrict the data to only authorized individuals. The use of a broker 14 in the system 20 allows the client 12 to remain anonymous to the plurality of archives 16. In some embodiments, there may be a plurality of brokers 14 as well. In such a distributed broker system, a separate challenge/response may be issued by challenge/response system 42 for each broker 14. Further, in addition to check fragments securing against loss, if something should cause an entire broker 14 system to be lost, the data from the lost broker 14 can often be recovered from the combination of the rest of the distributed brokers 14.

For example, consider a client 12 sends data fragments and challenge/response data to three brokers 14. Broker 1 may receive fragments 0-9 and challenge/response data, broker 2 fragments 10-19 and challenge/response data, and broker 3 may receive fragments 20-29 and challenge response data. In this scenario, client 12 can challenge each of the brokers 14. Further, each of the brokers 14 can challenge one another. This can greatly reduce the possibility of lost data or a broker 14 misusing the data. The number of brokers 14 may be any number, and in this case it would be assumed that each fragment was 1 mb of data, for a total of 30 mb of archived data. Each broker 14, therefore, received 10 mb of data. The assumption in choosing three brokers 14 is that all of the 30 mb of data could be recovered from 20 mb, so if one broker 14 fails, client 12 can still retrieve the full data file. It is to be understood that the values given here are by way of example and not intended to be limiting in any way.

The check fragments described above utilize a technique known in the art as erasure encoding. Erasure encoding effectively fragments the data such that any lost fragments may be recovered from a sufficient amount of the fragments, unrelated to which fragments are lost or corrupted. These fragments are distributed across the plurality of archives 16. This method is less expensive than traditional methods requiring large portions of data to be forwarded in the instance of a loss; however it also requires slightly more storage space for the archiving.

In combination with the erasure encoding is a system of challenge/response data. Unlike some traditional challenge/response data, the challenges and responses may be precomputed and stored in encrypted form at the plurality of archives 16. In the event of a major catastrophe, even the challenge/response data could then be retrieved. Challenge/response system 42 essentially issues challenges to determine if random subsets of the data are effectively archived. One major advantage of the combination of services is a resulting proactive repair. If a subset of data is missing in the challenge/response, the check fragments can be utilized to actively repair only the damaged or corrupted data subset. Previous methods would often forward the entire data file for archiving again. This allows minute recovery of data that typically would go unnoticed until entire files were corrupted, while cutting the cost of replicating the data.

For further security a key redistribution may be utilized. Key distribution/redistribution system 29 may issue an encryption key for each of the agents of the client. Each encryption key may be separated into shares. Each share of the encryption key may be entrusted to an individual, or a “share holder” of the encryption key, for example users 40 of FIG. 2. A certain percentage of “share holders” may be required to, for example, decrypt the data received back from the broker 14. The shares of the key or the whole key may be periodically or regularly redistributed to trusted individuals by key distribution/redistribution system 29. The key or shares may also be redistributed in the case of, for example, termination of an employee. Encryption key redistribution can reduce the risk of internal disclosure of information from, for example, disgruntled employees or previous employees, by requiring a certain number of trusted individuals with shares of a key to agree to any action, such as decryption, retrieval or recovery of data. A further benefit of key distribution by shares is that even if an individual gains access to a number of shares of a key, if it is not sufficient to fully reconstruct the key, nothing is learned about the key. It is to be understood that although specific examples of the benefits of key redistribution are given, they are not meant to be limiting and one skilled in the art would recognize other benefits of the service.

A further aspect of the invention includes a loss probability system 31 which, e.g., uses Byzantine fault values to mathematically compute an accurate probability of data loss or failure over a given time period. Loss probability system 31 makes it possible to more accurately bond or insure against such loss via a bond agent or insurance agent. Accordingly, many of the services are scalable depending on the size and needs of the client.

It is understood that computer system 20 may be implemented as any type of computing infrastructure. Computer system 20 generally includes a processor 22, input/output (I/O) 24, memory 26, and bus 27. The processor 22 may comprise a single processing unit, or be distributed across one or more processing units in one or more locations, e.g., on a client and server. Memory 26 may comprise any known type of data storage, including magnetic media, optical media, random access memory (RAM), read-only memory (ROM), a data cache, a data object, etc. Moreover, memory 26 may reside at a single physical location, comprising one or more types of data storage, or be distributed across a plurality of physical systems in various forms.

I/O 24 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 27 provides a communication link between each of the components in the computer system 20 and likewise may comprise any known type of transmission link, including electrical, optical, wireless, etc. Although not shown, additional components, such as cache memory, communication systems, system software, etc., may be incorporated into computer system 20.

Access to computer system 20 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wire line and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system 20 comprising an archiving system could be created, maintained and/or deployed by a service provider that offers the functions described herein for customers. That is, a broker 14 could offer to deploy or provide the ability to fragment data at a client 12 and archive data at a plurality of archives 16 as described above.

It is understood that in addition to being implemented as a system and method, the features may be provided as a program product stored on a computer-readable medium, which when executed, enables computer system 20 to provide a data archive client 26. To this extent, the computer-readable medium may include program code, which implements the processes and systems described herein. It is understood that the term “computer-readable storage medium” comprises one or more of any type of physical embodiment of the program code. In particular, the computer-readable medium can comprise program code embodied on one or more portable storage articles of manufacture (e.g., a compact disc, a magnetic disk, a tape, etc.) or on one or more data storage portions of a computing device, such as memory 16 and/or a storage system.

As used herein, it is understood that the terms “agent,” “client,” “broker,” “archive,” “program code,” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that terms such as “component” and “system” are synonymous as used herein and represent any combination of hardware and/or software capable of performing some function(s).

The block diagrams in the figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams can be implemented by special purpose hardware-based systems which perform the specified functions or acts, or combinations of special purpose hardware and computer instructions.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

Security and data management are two very interrelated areas of computing. Bishop describes security as ensuring confidentiality, integrity and availability of systems and their data. Here, we consider backup and recovery of data, and explore the sorts of security vulnerabilities introduced by a traditional backup system, with a focus on confidentiality, integrity and availability. Backups of confidential information are potential channels for data theft. An approach is presented in Section 8.4 that ensures confidentiality of backed up data. We propose the use of distributed key management systems to address availability and trust issues. Finally, we consider an approach to ensure the integrity of the individual backed up files and explore a novel pipelined approach using an integrated file system scan during the backup and recovery process in Section 8.5. Our analysis indicates that this approach closes the window of vulnerability to backup and restore related attacks.

### Related Work:

Anderson proposed a subscription based eternity service that supports remote archival of data as described in, with an eye toward preventing censorship (i.e. a focus on integrity and availability), by using fragmentation, redundancy and scattering of the data. Our approach, in contrast, supports operating under a strong confidentiality requirement not imposed in the eternity service model.

We rely on cryptographic protocols, and for efficiency we will use both symmetric key cryptography (in our preliminary implementation we use AES and public key cryptography approaches. Additionally, for key management, we utilize threshold schemes for secret sharing.

Erasure encoding is a useful tool to improve data availability with less storage and bandwidth overhead than data replication in distributed and peer-to-peer systems. Our work uses efficient rated erasure codes, similar to those described by Luby, et al.

We use randomized sampling for fault detection and rely on consensus based protocols and secret sharing for confidentiality. Computing shares in the presence of dishonest participants is called cheating; D'Arco et al. have recently developed cheating immune forms of shared secrets protocols. Verifiable approaches are used to expose dishonesty, Wong, et al., have developed an approach for verifiable secret sharing for data that is backed up via distributed replication. Castro and Liskov developed a Byzantine fault tolerant system, which is suited for establishing consensus about versions of distributed replicated objects in networked file systems. Kubiatowicz, et al., developed Oceanstore, which is a distributed versioning file system with persistent replication. Oceanstore uses a trusted “inner ring” of servers for caching authoritative copies, with a variant of the Castro Liskov Byzantine fault tolerant model for establishing consensus about versions among the servers. Aiyer, et al., recently presented a treatment of Byzantine fault tolerance where nodes were considered altruistic (correct), Byzantine (unpredictably faulty) and rational (following a known optimization strategy), with applications to a peer-to-peer backup system. Recent work by Kotla, et al. focuses on using erasure encoding combined with fault detection to improve availability, but requires periodic retrieval of fragments for remote auditing of data integrity. There have been several theoretical treatments of proof of retrieval or proof of data possession protocols in the literature.

### Design Overview

In this paper we focus on providing secure backup and recovery measures. Traditional backup mechanisms have focused on availability. We seek to extend and improve availability while addressing issues of confidentiality and integrity. In this context, the major security guarantees are as follows.
1. Confidentiality, which means that only authorized restore agents should be able to read the plaintext backup.
2. Integrity's classical definition refers to disallowing unauthorized writes or deletion. We consider authentication to be defined as ensuring integrity of origin.
3. Availability refers to guaranteed legitimate access to resources by users.

It should be noted that security violations are frequently modeled as faults, which can either be detectable (fail stop) or undetectable (Byzantine), making fault tolerance critical for distributed systems design. Our design seeks to avoid the higher overhead of Byzantine fault tolerance by rendering faults detectable and imposing accountability on faulty entities. Finally we present an efficient and novel approach to harden the broker using a consensus based approach, where we trade off a small number of additional small messages to avoid additional expensive retransmission of large messages.

### Required Properties of the Computing Environment

### We Assume:

1. A synchronous distributed computing environment with the following entities:
   a. clients requesting storage of backups for a specified duration, like Anderson's Eternity service, except that document retention policy enforcement requires backups to become unrecoverable upon expiration.
   b. archival sites providing storage,
   c. broker(s) providing client anonymity and archive access for clients (including media conversion).
In future portions of the paper the archives and broker will be considered the server side of the system.
   d. Low bandwidth secure data channels exist between all nodes for distribution of small amounts of secret data (shares), with all other channels assumed insecure but providing confirmed delivery. It should be noted, while backing up over a network is often appropriate, for many applications removable media approaches may be required for bandwidth and capacity reasons and are accommodated by our assumptions.
   e. The availability of public key encryption, collision resistant hashes and digital signatures.

### Our Approach

We use public key cryptography to enforce end-to-end confidentiality during both distribution of the backup over insecure channels and storage on (potentially) insecure media. Very long term persistence of backups implies that the set of authorized restore agents is likely to change during the backup's lifetime. Therefore, distribution of trust and key management via secret sharing is needed to prevent a single defector (or a small number of defectors) from leaking a copy of the encrypted backup and revealing the encryption key. To promote security, we have provided (optional) privilege separation for the client, so that integrity testing and communication do not require divulging the key used to access the data. Additionally, document retention policies have motivated the use of Hippocratic data management approaches, which guarantee deletion of data after access authorization has expired. We develop a novel Hippocratic data management approach using Byzantine consensus to revoke all shares of the encryption key upon expiration as a mechanism.

Proactive monitoring of the replicas via the construction of single-use proofs of integrity (with high probability) ensures that archival nodes do not silently discard or corrupt data. We provide for a challenge response protocol that allows either the optional use of a trusted client copy approach or a precomputed challenge/response lists for validating digests. Integrity of origin (authentication) is ensured by a time stamped digital signature attached to each message. Backups are considered large messages.

We ensure availability via erasure coding. Additionally we utilize dynamic data redistribution which supports control over the jurisdictions where data is stored and allows for optimization of storage costs. Hippocratic data management requirements specify strict limits on availability, which are enforced by a consensus based key revocation by clients. Thus it is not necessary to trust archives to delete data nor are secure channels required for data distribution.

### 4 Value to Set Maps and Their Notation

Redistribution of erasure encoded fragments is done by changing a mapping from a value to a set of values (we use this approach to map erasure encoded fragments to archives), which we express as a set system, which is formally defined as follows.

Definition 1 [Value to Set mapping] Given a domain of values D={1, 2, . . . , m} and a target set of values R={1, 2, . . . , n}, we denote a value to set mapping as M:D->2^{R}, where 2^{R} is the power-set of the target. We can treat the mapping as a set of ordered pairs: M={(i, r_i)|(i∈D)Λ(r_i⊂R)}
Please note that M(D,R) describes a one-to-many mapping from D to R.
We define the following binary operators on value to set mappings.
Definition 2 [−, ␣ and [symbol] operators for value to set mappings] Given a domain of values D={1, 2, . . . , m} and a set of target values, R={1, 2, . . . , n}, let A={(i, aᵢ)|i∈D, aᵢ∈R} and B={(i, bᵢ)|i∈D, bᵢ∈R} both be value to set mappings from D to R. The binary operators −, ␣ and [symbol] are defined as follows.

A−B={(i,aᵢ−bᵢ)|i∈D,aᵢ,bᵢ⊂R}

A␣B={(i,aᵢbᵢ)|i∈D,aᵢ,bᵢ⊂R}

A [symbol] B={(i,aᵢbᵢ)|i∈D,a₁,bᵢ⊂R}

Additionally, we define relational operators for maps.
Definition 3 [Containment [symbol] , proper containment [symbol] ] Given D={1, 2, . . . , m} and target R={1, 2, . . . , n}, let A={(i, aᵢ)|i∈D, Λaᵢ⊂R} and B={(i, bᵢ)|i∈DΛbᵢ⊂R}A and B be value to set mappings from D to R. We define the following relational operators for maps A and B:
A=B A equals B if ∀ i∈D, aᵢ=bᵢ,
A [symbol] B A contains B if ∀ i∈D, aᵢ⊂bᵢ, and
A [symbol] B A properly contains B if ∀ i∈D, aᵢ⊂bᵢ.
We introduce following operators to manipulate mappings:
Definition 4 [MapAddEdge, MapDeleteEdge, MapDeleteTargetEdges] Given a domain D={1, 2, . . . , m} and target R={1, 2, . . . , n}, let A be a value to set map, A={(i, aᵢ)|i∈DΛaᵢ⊂R}. Let x∈D and y∈R. The following operators are defined:
MapAddEdge(A,(x,y))=A␣{(x,{y})}
MapDeleteEdge(A,(x,y))=A−{(x,{y})}
MapDeleteTargetEdges(A, y)=A−(␣_{x∈D}A−{(x,{y})})
We also may wish to categorize which domain elements have nonempty edges, the number of non-empty mappings, and the number of edges in the map.
Definition 5 [NonEmptyMapCount, MapEdgeCount] Given a domain of values D={1, 2, . . . , m} and a set of target values, R={1, 2, . . . , n}, let A={(i, aᵢ)|i∈D, aᵢ⊂R}, the number of nonempty maps and the number of edges are denoted:
NonEmptyMaps(A)={(i, aᵢ)|i∈DΛaᵢ≠φ}

### NonEmptyMapCount(A)=|NonEmptyMaps(A)|

MapEdgeCount(A)=Σ_{i∈D}|aᵢ|

### 5 Architecture of A Distributed Archival System

We begin by considering the overall computational model, and then describe the cryptographic primitives used and the model of the adversary.

### 5.1 Computational Model

Consider a system, where there is a set of x clients wishing to have secure archival of their on-line data, denoted C={c₁, c₂, . . . , cₓ}. Let cᵢ denote the ith client, where 1≦i≦x, would have a sequence of yᵢ erasure encoded data objects to archive (e.g. file system dumps) [d_{i,j}]^{m}_{i,j}^{,n}_{i,j}, where 1≦j≦yᵢ. The system also has a set of z data repositories, called archives denoted A={A₁, A₂, . . . , A_{z}}. We denote the set of archival nodes participating in the storage of [d_{i,j}]^{m}_{i,j}^{,n}_{i,j} at as A_{i,j}⊂A. We represent the set of available (correctly functioning) archives at time t as A(t), and let A_{i,j}(t)⊂A_{i,j} denote the set of correct archives in A_{i,j} at time t.

We utilize a hybrid peer-to-peer model, where there is a centralized service provider, called a broker whose responsibilities include managing the verifiable archival of data and retrieval from the archives upon a client's request, but do not necessarily include actually being a repository for the archived data. The client's subscription may have a restore cost proportional to the bandwidth used, since there may be a large data transfer in the event of a restore. The broker can be thought of as subcontracting with a set of archives denoted A={a₁, a₂, . . . , am}. Data is transmitted from clients to the broker either via a network connection or via removable media, and the broker then redundantly stores the data across a set of archives as seen in FIG. 1.

We use a Byzantine fault model for the broker and archival systems, i.e. faulty nodes can have arbitrary behavior. Clients are considered to be outside the control of the archive system and are trusted entities.

The broker and client each need to track the mapping from each erasure encoded fragment and its metadata, denoted f_{i,j,k} as defined in equation, to the set of archives holding images of f_{i,j,k}. More formally, we define a fragment to archive mapping as follows.

Definition 1 [Fragment to archive mapping] Given a data object d_{i,j} backed up over a set of archives at time t, A_{i,j}(t)⊂A (t), we define a fragment to archive mapping as a value to set mapping (see definition 4) of erasure encoded fragments and their metadata, denoted f_{i,j,k}, with 1≦k≦n_{i,j} is stored on the set of archives fa_{i,j,k}(t) at time t. Let F_{i,j}(t)={f_{i,j,k}|1≦k≦n} The mapping FA_{i,j}(t):F_{i,j}−>2^{A}_{i,j}^{(t)}, where 2^{A}_{i,j}^{(t)} is the power-set of A_{i,j}(t), can be represented as a set of ordered pairs:

FA_{i,j}(t)={(k,fa_{i,j,k}(t))|1≦k≦n_{i,j}Λfa_{i,j,k}(t)⊂A_{i,j}(t)}

### 5.1.1 Cryptographic Primitives Used

We use data encryption to prevent eavesdropping and spoofing. Given a message M and a key k the encryption of M by k is denoted {M}k. For symmetric key cryptography, we treat the encryption as being its own inverse operation, so M={{M}ₖ}ₖ For public key encryption, we will typically denote the private key as k and the public key as k⁻¹, noting that we can consider the two keys as being used to perform inverse transformations on the input. We denote encryption with the corresponding public key,k⁻¹ as {M}ₖ⁻¹. Decryption is thought of as the inverse operation, so decrypting with the private key is denoted {{M}ₖ⁻¹}ₖ. We assume that the public keys of all participants are known the other participants.

Our messages will contain message authentication codes (MACs), to detect corruption. We denote the message authentication code of a message M by a collision-resistant hash function as D(M). We also employ public-key digital signatures to detect forged messages. The signature of a message M by node i, using private key kᵢ is denoted as <M>ₖᵢ.

### 5.1.2 Data Communication and Message Formats

Every message in our system has metadata containing the following fields in its header.
1. Source identifier of the sender of the message,
2. Destination identifier of the recipient of the message,
3. Time out duration for this message,
4. A sequence number in the interval [0, S-1].

All messages will have a trailer consisting of a cryptographic signature, computed from the header and the payload, that can be used to verify both integrity of origin and data integrity of the message.

### 5.1.3 Model of the Adversary

We allow for a strong mobile adversary that can coordinate faulty nodes, delay communication, delay correct nodes, attempt to insert false messages into the communication channels, and read real messages from the channels. We assume that the adversary cannot delay correct nodes indefinitely. We also assume that the adversary (and the faulty nodes it controls) is computationally bound so that (with very high probability) it is unable to subvert the cryptographic techniques mentioned above. For example, the adversary cannot produce a valid signature of a non-faulty node, compute the information summarized by a digest from the digest. Given recently discovered techniques that efficiently discover collisions of cryptographic hash functions (e.g. Wang and Yu and Wang, et al.), we are considering approaches to ensure collision resistance including self interleaving and message whitening as proposed by Szydlo and Yin and possibly using multiple independently computed hashes over the same data.

### 5.2 Simplifying Assumptions Made

To facilitate the design we make the following reasonable but simplifying assumptions.
1. cᵢ and B know each other's public keys and the public keys of all aₓ∈A(t)
2. The cᵢ has registered with B, who has assigned cᵢ the unique identifier i.
3. cᵢ is able to maintain a copy of d_{i,j} until the initial dissemination succeeds.
4. All clients, brokers and archives have well known network addresses, which may be accessed using a secure form of DNS.

### 5.3 Distributed Archival Requirements Analysis and Design

Given our architectural and adversarial model described above and the joint design goals of efficiency and security (i.e. confidentiality, integrity and availability), our approach requires the following features and operations.
1. The client, cᵢ must be able to communicate in a confidential and verifiable manner with other parties participating in the backup of d_{i,j}. We enable this via a public/private communication key pair (CCK_{i,j}⁻¹, CCK_{i,j}).
2. cᵢ may represent an organization wishing to securely archive data, and hence cannot be viewed as a single trusted entity. We therefore:
   a. Support separation of privilege, via a distinct public/private restore key pair (CRK_{i,j}⁻¹ and CRK_{i,j}) for encryption and decryption of d_{i,j}.
   b. Distribute trust via distributed key generation and proactive threshold key cryptography with secure secret share redistribution in order to foil mobile adversaries, support organizational change during archival and to prevent a small number of defectors in an organization from corrupting or leaking the data.
3. cᵢ and B must be capable of verifying the integrity of the archival of each data fragment, e_{i,j,k}, as described in Section 7.7. Thus, the client is responsible for both encoding the representation used to store d_{i,j} and computing any metadata needed for integrity testing. Note that if the requirement for independent client verification of data integrity is relaxed, then cᵢ (by definition) treats B as trusted5 and simplified variants of the protocols can be derived where B provides these services for cᵢ.
4. Our services will require authentication and non-repudiation (i.e. integrity of origin), thus messages will be digitally signed. In cases where signed messages are relayed by an intermediate node, that node will retain signatures and append its own.
5. cᵢ or B must be able to recover the backed up image of the ciphertext {d_{i,j}}_{kdi,j} in the presence of a sufficiently small number of failed archives, as seen in Section 7.17. Due to the expense, archives may support a limited number of restore requests, before surcharging for additional restores. Please note that only cᵢ should have access to k_{di,j} and making it hard for B to derive the plaintext.
6. cᵢ or B can adjust the set of sites A_{i,j,t} archiving e_{i,j,k} (see Section 7.11 for details).
7. After the subscription, lapses (after time t+τ) correctly working members of A_{i,j,t+τi,j} may purge their data and any corresponding metadata.

### 6 Distributed Server Side Backup Approach

Consider a single client, cᵢ, making a backup using a hybrid peer-to-peer model, with a broker B, that delegates storage of the erasure coded backed data object for duration τ_{i,j} to some subset of archives as shown in FIG. 1.

6.1 Distributed Data Representation: Erasure Encoding vs. Replication

In order to promote fault tolerance and availability, we use redundantly store data, of which there are two widely used forms in practice:
1. replication, which redundantly stores the exact copies of the data and
2. erasure encoded representations of d_{i,j} have n_{i,j} encoded fragments and can reconstruct with some subset of those fragments. Rated erasure codes guarantee decoding d_{i,j} of the original data given a subset of at least m_{i,j} fragments, with the ratio r_{i,j}=[(n_{i,j})/(m_{i,j})] being called the rate of the erasure encoding. Rateless erasure encodings have probabilistic, but not absolute guarantees about the number of fragments needed for reconstruction, but do not bound n_{i,j}, and hence are often used for digital fountains.

The choice of data representation impacts availability, the bandwidth, storage and computational costs incurred. Weatherspoon and Kubiatowicz analysis of peer-to-peer systems indicated that erasure codes provide higher availability for the same storage and bandwidth costs as a replication based approach, even when a moderate number of archives are used. Erasure encoding does, however, make integrity testing more challenging and causes repairs to require reconstruction of missing fragments. Moreover, due to the length of archival storage, it is likely that integrity tests and data redistribution (motivated by availability or cost requirements) may occur during τ_{i,j}. In spite of this, we feel the availability gains offset the increase in complexity and hence use an erasure encoded representation.

6.2 Broker based Archive Registration

Given the presence of a broker, the broker tracks the set of archive nodes at time t, denoted Aₜ. On the Internet, we require as a precondition to registration that every archive registers its domain name using secure DNS (to make impersonation harder). Archives wishing to sell their services then register with the broker via the following method.
1. An archive aₓ wishing to register transmits a message to the broker with the following information
   a. aₓ's storage and bandwidth capabilities, including costs
   b. aₓ's public key, signed by a certificate authority the broker trusts.
2. The broker verifies the information presented by the archive, and either accepts or rejects the registration, at the broker's discretion.

### 6.3 Fault Detection and Tolerance

Invariably, in any sufficiently long lived system, eventual component failure is likely. The first step in resolving failures is to determine the design goals, i.e. do we want deterrence, vengeance or restitution, as described in Section 6.3.1.

### 6.3.1 Error Handling Design Criteria

The primary goal of any archive system is to preserve the data entrusted to it. Accordingly, we utilize the following guidelines concerning failures.
1. In the event of failure, damage control and repair are more important than punitive measures.
2. A good failure recovery strategy should be able to exploit early knowledge of failures, hence, a node that has early voluntary error disclosure should be assessed a lower cost than an archive that hides the error until discovered.
3. A node that is failed, and wishes to have fail status lifted must pay the recovery costs incurred by the injured parties.
4. Nodes, while marked as failed, are not eligible to store new data objects, nor may they receive a new portion of current data objects. Financial penalties may also be incurred.
5. Sufficiently severe or recurring failures may result in permanent sanctions.
   6.3.2 Challenge-Response for Data Integrity Verification using Randomized Sampling

One concern of the client or broker is that, over time, a sufficient number of archives holding fragments of d_{i,j} could fail, causing irreparable loss of data. More formally, at some time, t₀, there may be sufficiently many working archives holding fragments to support reconstruction, i.e. |A_{i,j}(t₀)|≧m_{i,j}, at a later time, t₁>t₀, too many archives could fail, leaving a working subset of size |A_{i,j}(t₁)|<m_{i,j}, causing data loss to the client. We take the proactive approach of periodically testing archive integrity to make this event extremely unlikely. Since both the client and the broker have a stake in the data, we allow either the client or the broker to perform these tests.

First, let's consider a single round of testing, at archive aₓ∈fa_{i,j,k}(t) of some data at time t. For our purposes this would happen to be the erasure encoded fragment e_{i,j,k}. For notational convenience we will assume that the broker B is performing the integrity test, however, the client could do so either directly or using the broker as a proxy. In order to prevent the archive from storing only the results of the integrity test, the parameters and the results of all integrity tests are not known to the archive prior to the administration of the test. As a precondition, we assume that the test administrator, i.e. the broker, B, knows the parameters and the results of the test. We assume that a collision resistant message digest is available. Our test, called the challenge, has the nonce parameters Challenge_{i,j,k,x}=(L_{i,j,k,x},U_{i,j,k,x},N_{i,j,k,x}), where 0≦L_{i,j,k,x}≦U≦|e_{i,j,k}|, specifies an interval of positions in the data e_{i,j,k}, and N_{i,j,k,x} is an optional nonce random unsigned integer with the same number of bits as the digital signature scheme used (i.e. if omitted, the challenge contains only the intervals and the default of N_{i,j,k,x}=0 can be assumed). The correct response to the query is also a nonce, Response_{i,j,k,x}=D(DataInterval(F(,N_{i,j,k,x}),L_{i,j,k,x},U_{i,j,k,x})), where F(e_{i,j,k}, N_{i,j,k,x}) denotes a function that produces a unique bit pattern with the same length e_{i,j,k}, and returns e_{i,j,k} when N_{i,j,k,x}=0, (e.g. the repeated application of the bitwise exclusive or operator on the shorter pattern N_{i,j,k,x} on the longer message e_{i,j,k}). Each challenge response pair can be expressed as ChallengeResponse_{i,j,k,x}=(Challenge_{i,j,k,x}, Response_{i,j,k,x}). Please note that if the N_{i,j,k,x} parameter is omitted, or is set to a default value, it can be shown that there are O(|e_{i,j,k}|²) distinct intervals, where |e_{i,j,k}| is the length of an erasure encoded fragment, hence an expensive but feasible attack of precomputing all responses can be avoided by using the nonce N_{i,j,k,x}. The above intervals should be chosen to have a uniform distribution over the file, and some intervals must overlap or an archive may be able to undetectably discard portions of the data. It is not necessary, however, to uniformly sample the entire file every test as the archive possesses no knowledge of the intervals of the next test.

Periodic testing is supported at regular intervals, say Δt_{i,j,k}, on archive aₓ∈fa_{i,j,k} for the erasure encoded fragment e_{i,j,k}. Thus we need C_{i,j,k}=┌τ_{i,j}/Δt_{i,j,k}┐ challenge response pairs. Each testing entity has a confidential list of parameter, response pairs, which it maintains CR_{i,j,k,y}=[ChallengeResponse_{i,j,k,0}, ChallengeResponse_{i,j,k,1}, . . . , ChallengeResponse_{i,j,k,N}], where for notational convenience we introduce N=C_{i,j,k} for this section only and where y∈{B, cᵢ}. Remote archival of challenge data is done to maximize its availability, and we require encryption to preserve confidentiality during transmission and storage on untrusted systems. For efficiency, each list is encrypted with a corresponding nonce session key, as described in Section 7.5. The nonce session key is in turn encrypted with the public key of the agent using the challenge-response list. In addition, we embed metadata indicating which client, backup and fragment is contained, to allow recipients to allow for unambiguous identification of the related fragment. To support independent verification of archived data, our approach requires that cᵢ computes a message cf_{i,j,k} containing e_{i,j,k} and cᵢ's integrity metadata, while the B computes it integrity metadata, bf_{i,j,k} which is used to augment this data to create a message. f_{i,j,k}.

cf_{i,j,k}=<<i,j,k, e_{i,j,k}>_{CCKi,j},<i,j,k,{k_{CRi,j,k,ci}}_{CCKi,j}^{˜1},{CR_{i,j,k,ci}}_{kCRi,j,k,ci}>_{CCKi,j}>_{CCKi,j}
bf_{i,j,k}=<i,j,k, {k_{CRi,j,k,B}}_{kB}⁻¹, {CR_{i,j,k,B}}_{kCRi,j,k,B}>_{kB}
f_{i,j,k}=<cf_{i,j,k}, bf_{i,j,k}>_{kB}

We require that any archive, aₓ storing e_{i,j,k} must concurrently maintain the associated metadata and deliver it to the appropriate party upon request. More precisely, any such aₓ must maintain f_{i,j,k} and cᵢ or B may, if needed, use the retrieve challenge response list protocol described in Section 7.8 to recover their integrity metadata.

### 6.3.3 Fault Detection and Tracking

Given a collection of entities (i.e. the client, archives and broker) participating in the storage of a given backup d_{i,j} we need a mechanism to detect, and to track the availability of those entities.

We define a node as being available if it has always satisfied the protocol correctness criteria which we define as follows.

Definition 1 [Protocol Correctness Criteria] An entity involved in the protocols described below must obey the following properties.
1. All expected response messages will be sent in a timely fashion, i.e. the recipient may time out.
2. All messages are to have format and content compatible with the protocol specification (including specified digital signatures).
   The criteria above are needed for the following reasons.
1. Non-responsive entities inflict a state saving burden on other parties to the communication, and withhold requested data.
2. Entities sending malformed message at best consume resources needlessly, and at worse induce data corruption.

Thus, in the event that a violation of protocol correctness occurs, the offending entity needs to be identified for the following reasons:
1. to limit wasting of resources,
2. to minimize the likelihood of data loss through the replacement of failed entities and
3. ensure that the appropriate party can be held responsible for restitution.

A third party (called a witness) capable of observing all relevant communication (or lack there of) between two entities in communication, can differentiate between link failure, non-responsiveness, or premature assertion of non-responsiveness. Witnesses are often used in protocols, including Aiyer, et al's BAR Fault tolerance. Since other entities cannot independently verify the witnesses fault detection and reporting, trust must be delegated to the witness. To accurately determine availability, message format and content must be also verified. For reasons of communication efficiency, and the desire to minimize the number of trusted entities, we define a trusted witness that performs the following functions.
1. Figure out what went wrong—Recording of sufficient information to determine if a protocol violation occurred. Recall the protocol correctness conditions in definition 6.3.3, the violations must be of the following forms.
   a. Timing related conditions:
      i. Tardiness in generating a response message, resulting in a timeout condition.
      ii. Falsely asserting a timeout condition has occurred when in fact a message was delivered in a timely fashion.
   b. Generation of incorrect messages in either format or content.
2. Determining out who did it—If a protocol violation occurred, the witness must identify the offending parties.

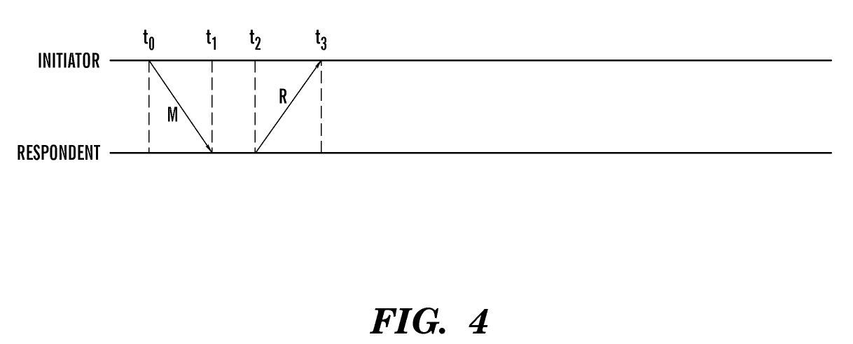

Using the approach of stepwise refinement, we can derive a correct yet efficient design for the witness. Many of our protocols are of the form shown in FIG. 4, where one entity is an initiator, starting a communication protocol, while the other is a respondent providing a service requested by the initiator (sort of like client and server based approaches). The following actions are depicted:
1. The initiator sends a message, M to the respondent at time to.
2. The respondent receives M at time t₁.
3. The respondent and computes a reply R and transmits R at time t₂
4. The Initiator receives R at time t₃.

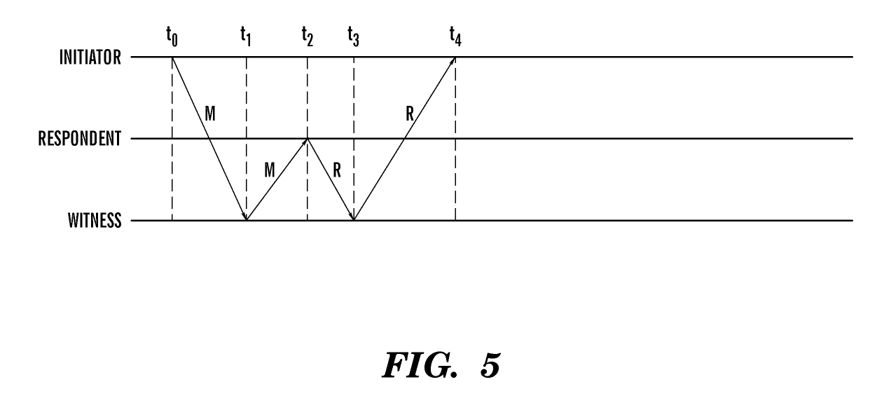

Although our high level protocols are far more complex than the simple point-to-point service protocol of FIG. 4, this can act as a sort of primitive which is used at each stage of the higher level protocols, so if we can get this right, this will allow us to ensure the protocol correctness constraints for higher level protocols. The simplest approach that supports correct trusted witness functionality is to treat the witness as a proxy for point-to-point service protocols, as shown in FIG. 5 which we refer to as slow mode.

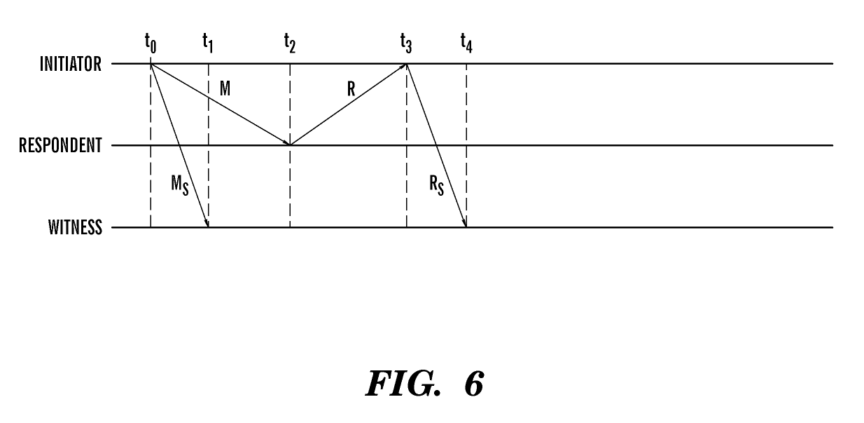

Note that the proxy observes all traffic involved in the point-to-point protocol in such a model, simply relaying messages. However, the bandwidth (and potential storage) costs for such a protocol can become prohibitive. We also anticipate that if p is the probability of a protocol failure, that we can expect p<<1, so applying the adage “make the common case fast and the rare case correct”, we look for a way to accelerate the processing of correct traffic, which we call fast mode, and only revert to slow mode when it is not possible for the witness to confirm that the protocol was successfully completed, as seen in FIG. 6.

In fast mode, non-responsiveness will prevent the response summary from being delivered to the witness, and, for correctness, will cause the protocol to revert to slow mode. Recall that our protocols specify that all traffic is digitally signed, hence malformed traffic has one of the following errors:
1. The message has a correct signature, but the content has invalid values or format, in which case the receiver may press charges with the witness via an immediate disputation (as described below).
2. The message has an incorrect signature.
   a. If the channel is injection resistant i.e. has encrypted traffic or is otherwise secured, the receiver should immediately dispute the message (like correctly signed messages), as described below.
   b. If the channel is not injection resistant the receiver should ignore the message, which could potentially cause a reversion to slow mode for transaction replay (as described above).

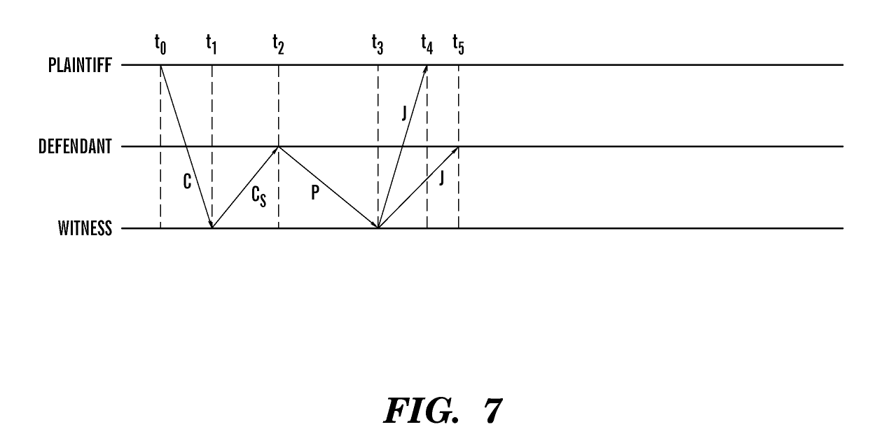

In some protocols, (e.g. integrity testing using challenge-response, as described in Sections 6.3.2 and 7.7), there are errors that depend on information that the witness may not have available in the current protocol exchange. Moreover, in fast mode the witness is not directly monitoring communications and hence does not have sufficient information to evaluate form or content errors. Thus we make it possible for either entity to become a plaintiff and formally place a charge to the witness that the other entity (called the defendant) has violated the protocol. Since it is also possible that incorrect entities may make false accusations, we allow for the defendant to submit a defense that refutes the charge. A disputation protocol works as is shown in FIG. 7.

As a precondition to the disputation protocol, we assume that the following cryptographic keys are established, and that the public keys are well known while the private keys are secrets belonging to their owner.
1. The plaintiffs public key pₖ⁻¹ and private key pₖ.
2. The defendant's public key dₖ⁻¹ and private key dₖ.
3. The witness' public key wₖ⁻¹ and private key wₖ.
   The following steps are performed in disputation.
1. The plaintiff detects a protocol violation and immediately contacts the witness with the charge message at time t₀. The charge message, C=<<Cₛ>ₚₖ, <Cₑ>pₖ>ₚₖ is composed of two parts:
   a. A charge summary, <Cₛ>ₚₖ describing what the nature of the complaint.
   b. A charge evidence, <Cₑ>ₚₖ consisting of protocol specified information the plaintiff uses to substantiate its claim. If the witness was in slow mode this information may already be available to the witness, and hence may not need to be retransmitted.
2. At time t₁, the witness forwards a signed message, <<Cₛ>ₚₖ>_{wk} including a copy of the charge summary to the defendant.
3. At time t₂, the defendant receives the charge summary from the witness, and assembles its plea, P which is one of the following forms.
   a. A guilty plea confessing to the charge (which may reduce the penalty and may include an offer of restitution to the plaintiff).
   b. A not-guilty plea which will contain protocol specified data refuting the charge. If the evidence is already available to the witness (i.e. via slow mode), the defendant need not redundantly send the information.
   c. Failure to respond, which the witness will treat as a guilty plea, but typically with more severe sanctions.
   A correct defendant transmits it's signed pleas <P>_{dk} to the witness.
4. The witness then acknowledges that it has gathered sufficient information to decide guilt or innocence and broadcasts to the defendant and plaintiff a notification, J that the evidence is complete, in a signed message, J=<WitnessEvidenceComplete, Cₛ>_{wk}.

For adjudication, that is passing judgement on the evidence and specifying which party is guilty, one of the following approaches can be used.
1. The evidence can be transmitted to any adjudicating authority, which then processes it and issues a decision after <J>_{wk} has been received by the plaintiff and defendant.
2. The evidence can be evaluated locally by the witness, who then acts like a judge, in which case <J>_{wk} can contain judgement information in addition to notification of receipt of all evidence. This method is preferred as it allows for a reduction in the amount of data communication, and (if we don't require verification of the trusted witness) storage overhead. Then, in the adjudication protocol, J=<WitnessAdjudicationComplete,Cₛ, guilty, remedy>, where:
   a. Cₛ is a judges charge summary
   b. guilty identifies who is at fault, guilty∈{P, D}
   c. remedy

### 6.3.4 Trusted Witness Design

In the interest of fairness, we want to avoid bias favoring one of the parties in the disputes the witness is adjudicating. Thus we use equal representation in designing our witness as a Byzantine consensus system (following the Castro-Liskov approach), such that the collection of archives, the broker and the client each get an equal number votes. Recall from Section 5.1.1, that messages employ cryptographically secure authentication. Thus, we use a three-entity replicated state machine using a Byzantine consensus system consisting of the client, the broker and the collection of archives. Each party may in turn employ a Byzantine consensus system to implement their representative. Under such a system the witness will operate correctly with at most one entity (or representative) failing in a Byzantine manner.

Given the client's presumably limited storage and bandwidth capabilities, and it's desire to remain anonymous it would be advantageous to provide facilities enabling the client to designate an agent to speak on it's behalf, and if storage and bandwidth for the witness were provided by an external service. Following our fault model above, this service should be paid for equally by the client, the broker, and the archives collectively. A storage service favoring one entity will antagonize the other two, thereby jeopardizing ⅔ of the revenue stream. To accommodate an irrational storage service the witness must be able to switch services at will.

### 6.3.5 Response to Detected Failures

To ensure that the state of the system remains consistent across all participants, a correctly operating entity should only respond to an error if the witness holds a record of that error. Please note that this implies adjudication is complete for that error. To prevent failed nodes from consuming system resources, correctly functioning nodes involved in a dispute should not initiate further communication about the dispute prior to adjudication. In general, the proper response to an error is context sensitive, i.e. it depends upon both the type of entity that malfunctioned and the aggrieved entity. Below are listed the proper actions to take for each of the entity types.

The following rules apply for the client cᵢ.
1. If the broker B is in error cᵢ should choose a new broker and invoke the Broker Replacement Protocol given in Section 7.18
2. If an archive aₓ is faulty B should delete the archive from the fragment-to-archive mapping as in Section 6.3.6
   The broker, B, should follow these rules:
1. If the client cᵢ is faulty there isn't much B can do besides refusing to store new archives from that client.
2. If an archive aₓ is in error, as above, B should follow the procedures in Section 6.3.6
   An archive aₓ can take the following actions:
1. If cᵢ is acting incorrectly aₓ should notify the broker of the error, and refuse to accept further backups from cᵢ.
2. If B is in error, aₓ should refuse to accept further backups from B.

### 6.3.6 Archive Failures

When an archive malfunctions it seems reasonable to remove them from the mapping for the given data object. Accordingly, given a failed archive aₓ,a fragment to archive mapping FA_{i,j}(tₕ), and an archive to fragment mapping Errors, failures are handled as follows:
1. FA_{i,j}(tₕ₊₁)=MapDeleteTargetEdges(FA_{i,j}(tₕ))
2. For all (k, a)∈(FA_{i,j}(tₕ)−FA_{i,j}(tₕ₊₁))): MapAddEdge(Errors, (a,k))

### 6.3.7 Failure Recovery and Restitution

Should an entity fail, our main course of action is to ostracize the offender until they compensate the remaining entities for damages incurred. The severity of the penalty is a function of the type of error and the cost of repair. Note that since recovery cost tends be less with early disclosure, we provide an incentive for rational nodes to report faults as soon as they are locally detected. Entities that protest just accusations will bear the costs of the adjudication. The following varieties of failures can occur:
1. Archive
   a. Loss of data or integrity—An archive which early reports loss reimburses the Broker the cost of e_{i,j,k}. An archive performing scheduled maintenance, may preemptively notify the broker and pay for fragment migration and avoid penalties for data loss. Archives which have errors discovered through challenges or restore operations will occur additional penalties (usually some multiple of the recovery cost).
2. Broker
   a. The broker can fail to disseminate a backup to the archives after agreeing to arrange for storage. The client in this case has borne the cost of encoding and shipping the data, and the broker is responsible for reimbursing the client for these costs.
   b. An unresponsive broker can be “fired” by a client, and the client may claim the “insurance” bond. The size of the bond may vary based on whether the client can maintain access to the data by performing a change of broker, data loss should incur a larger penalty. False accusations by a client may also have penalties that are some multiple of the insurance bond, and are payable to the broker. Veracity of accusations can be ascertained via the trusted witness.
   c. A broker that is unresponsive to an archive has already paid any costs incurred by the archives Therefore no additional penalties are incurred, however, an error will be logged with the witness from which the client may take action.
3. Client

The client may fail to correctly erasure encode d_{i,j}. As the client has already paid all costs incurred by the other parties no additional fines are levied. The broker is, however absolved from performing block reconstruction, and the client forfeits the bond. The client, at their discretion may retrieve all remaining blocks of d_{i,j} and attempt to reconstruct itself which may take binomial(n_{i,j}m_{i,j}) reconstructions. If cᵢ succeeds it may generate replacement e_{i,j,k} blocks and reimburse the broker for all costs incurred in distribution of them.

If the client does not respond to a broker or archive, as above, no additional fines are levied. Recall that in the case of data reconstruction, B needs cᵢ to generate the challenge response lists for the reconstructed fragments. If the client, is unavailable to verify the hash tree when fragment replacement is required the broker may, after a suitable number of contact retries, be released from his insurance bond obligation. If the above occurs and enough fragments are lost that recovery is impossible, the broker and the archives may discard d_{i,j}.

### 7 Server Interface Protocols

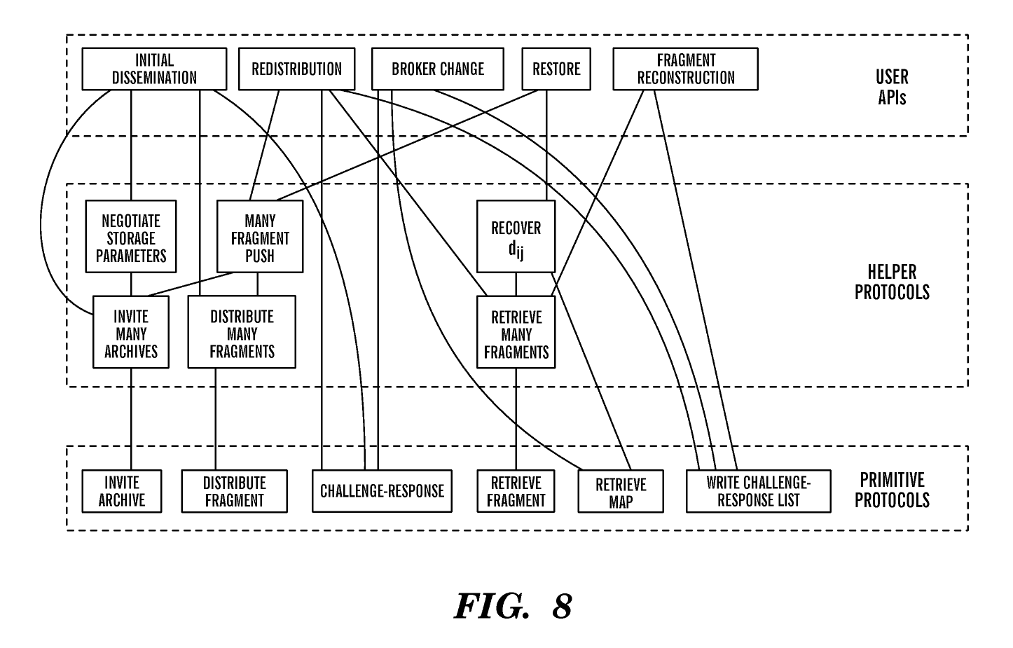

To develop a protocol suite, we decomposed our system based on services offered and created one protocol for each service. We use a protocol architecture as seen in FIG. 8.

Our model provides the following high level Application Programming Interface (API) protocols:
Initial Distribution—Makes a backup of some data object d_{i,j}, as seen in Section 7.5.
Restore—Retrieves a backed up data object, d_{i,j} for details see Section 7.17.
Redistribution—Changes the set of archives hosting a backup, see Section 7.11.
Fragment Reconstruction—A repair protocol that regenerates missing erasure encoded fragments and stores them on archives, described in Section 7.12.
Change broker—Changes the broker managing a backup as described in Section 7.18.
   All of these protocols use the following primitives:
Single Fragment Archive Storage Reservation—performs resource discovery for distributed storage described in Section 7.2.
Distribute Fragment—pushes data (i.e. an erasure encoded fragment) to an archive, for details see Section 7.3.
Challenge-Response—tests the integrity of some data on an archive, as seen in Section 7.7.
Retrieve Fragment—pulls data (i.e. an erasure encoded fragment) from an archive as described in Section 7.14.
Retrieve Mapping—pulls the archive map of d_{i,j} FA_{i,j}, from the broker, as presented in Section 7.19.
Write Challenge-Response List—transmits a challenge-response list to an archive for storage, as described in Section 7.9.
   For notational convenience and reuse we define the following helper protocol.
Many Fragment Push—given a set of fragments and a threshold number of required successful stores, finds available archives and stores at least the threshold number of fragments as presented in Section 7.4. This protocol in turn relies on the following protocols:
   1. Invite Many Archives—Invites a set of archives to host a set of fragments, for details see Section 7.10.
   2. Distribute Many Fragments—Pushes many fragments onto a known set of archives as seen in Section 7.6.
Retrieve Many Fragments—Pulls many fragments from a set of archives as described in Section 7.15.
Recover d_{i,j}—Retrieves erasure encoded fragments and reconstructs d_{i,j} for details see Section 7.16.

The remainder of this section is a bottom-up treatment of the protocol architecture, beginning with the primitives and then defining the higher-level protocols.

7.1 Client-Broker Storage Negotiation for d_{i,j}

This protocol is initiated by the client, cᵢ, to establish consensus with the broker, B, on the parameters governing the amount, cost, identification, and duration of storage for some data object, d_{i,j}. Prior to invoking this protocol, the following preconditions must hold
1. The public keys k_{B}⁻¹, CCK_{i,j}⁻¹ are known to both B and cᵢ.
2. Both B and cᵢ agree on a function F: Z×Z→Z, where Z denotes the set of integers, which given two unique parameters will generate an unique value. B and cᵢ will independently evaluate i=F(k_{B}⁻¹, CCK_{i,j}⁻¹).

The protocol to determine the value of j, the identifier of the backup with for a given client identifier i, does the following steps.
1. cᵢ generates a locally unique sequence number and transmits it to the broker<ClientlntialSequence, Csequence>_{CCKi,j}.
2. In response, B also generates a locally unique sequence number and transmits it to cᵢ via the message<BrokerInitialSequence, Bsequence>_{kB}
3. j=(Bsequence,Csequence) is unique for i if at least one of cᵢ or B correctly generates a unique sequence value.

This protocol allows B some freedom in estimating parameters and responding to rejected invitations. B may do any of the following:
1. Issue more invitations in the first round than the number of distinct fragments, n_{i,j}.
2. Elect to not distribute a sufficiently small number of fragments if some invitations are rejected.
3. Have one or more additional rounds of invitations to get n_{i,j} acceptances if some invitations are rejected.
4. Reject the storage request if too many invitations are rejected.
5. Reduce n_{i,j} by the number of rejected invitations, and decrease the rate accordingly so that there are n_{i,j}^{˜m}_{i,j} check fragments.
6. Pad the fragment size, f_{i,j,k}, and use a fixed rate, so that both n_{i,j} and m_{i,j} can be reduced in the event that some invitations are rejected.
   Once the i, j pair is established, the entities behave as follows
1. cᵢ will notify the broker of the desired storage parameters for archival of d_{i,j} via sending B the message we will call M for the remainder of this protocol, defined as M=<ClientRequestStorage, i,j, |d_{i,j}|, r_{i,j,max}, t_{i,j}, τ_{i,j}, n_{c,i,j}>_{CCKi,j} where,
         |d_{i,j}| is the size of d_{i,j} in bytes,
   t_{i,j}=[t_{i,j}.Start, t_{i,j}.End] is an interval (window of time) during which the data will arrive at the broker,
   τ_{i,j} denotes the duration of the backup,
   r_{i,j,max} is the maximum encoding rate that the client will accept for the erasure encoding of d_{i,j} (since this reflects client specific storage limitations) and
   n_{c,i,j} is the number of client issued integrity tests that the client expects to perform on the archives storing the encoded representation of d_{i,j} as described in Section 7.7 over the archival duration.
2. B will derive estimates (if feasible) for the following parameters.
   Invited_{i,j} is the set of archives it will invite to participate in storage.
   n_{i,j} is the total number of fragments generated by the erasure encoding, B can set n_{i,j}=Invited_{i,j} but n_{i,j} could be set to a lesser value if B wants to compensate for a small number of rejected invitations in step.
   m_{i,j} denotes the minimum number of fragments required to restore d_{i,j}.
   T_{i,j} is the minimum number of lost fragments allowed before fragment reconstruction is initiated,
         |f_{i,j,k}|≧[(n_{i,j}|d_{i,j}|)/(m_{i,j})]+|CR_{i,j,k,B}|+|CR_{i,j,k,ci}| is the projected size of an erasure encoded fragment, which can be set to exactly the lower bound if the B plans to abort, discard fragments or store multiple fragments on a single archive in the event that some invitations are rejected.
3. B uses its estimates computed in the previous step and performs the multiple archive invitation of Section 7.10. If the multiple archive invitation fails, the protocol is aborted, and sends cᵢ the message <BrokerRejectStorageRequest, M>_{kB}. B can either attempt to recover or fail depending on which of the above strategies is selected, and may adjust the erasure encoding parameters accordingly and proceeds to the next step.
4. B notifies cᵢ of its availability to service the request as follows:
   a. If B determines that it d_{i,j} is likely to be safely disseminated to the archives, B computes the set of EncodingParameters needed to specify the erasure encoding of d_{i,j}. B will then respond with the message G_{i,j}, where G_{i,j}=<BrokerAcceptStorageRequest, M, m_{i,j}, n_{i,j} EncodingParameters>_{kB}.
   b. If B determine that it cannot safely store the data (i.e. B has failed to get a sufficient number of accepted invitations), it can safely disseminate the data it will respond with <BrokerRejectStorageRequest, M>_{kB}.

### 7.2 Single Archive Storage Reservation

To assist in correctness and ease of implementation we define a primitive protocol for the broker, B, to reserve space on a particular archive, aₓ. The protocol requires the following client supplied parameters:
1. the client identifier (i),
2. the backup identifier ( ),
3. the fragment reservation identification number (r),
4. the estimated time of data delivery to archive aₓ, (t_{i,j,r,x}),
5. the duration of storage on archive aₓ, (τ_{i,j,r,x}),
6. the client's public communication key for this backup (CCK_{i,j}) and
7. the estimated amount of storage needed, (storage_{i,j,r}).
8. the public key of the destination archive aₓ, kₐₓ⁻¹ (used to uniquely identify the destination archive)

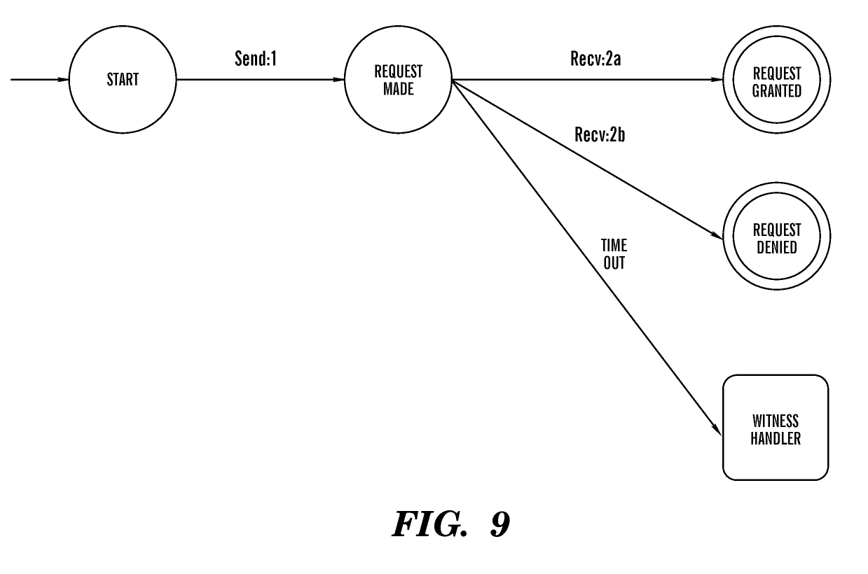

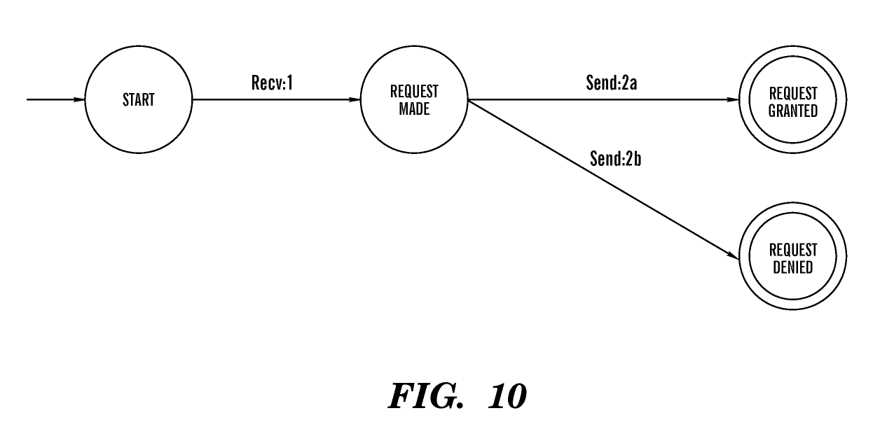

The broker following this protocol has a deterministic finite automaton (DFA) as shown in FIG. 9, while the archive has the DFA shown in FIG. 10. The protocol returns the invitation response, R, and proceeds as follows:
1. B sends to aₓ<BrokerRequestArchiveSpace, i, j, k, CCK_{i,j}, storage_{i,j,r}, t_{i,j,r,x}, τ_{i,j,r,x}, kₐₓ⁻¹>_{kB}.
2. A correct aₓ will do one of the following.
   a. Grant the request, reserve the space, and send B a message indicating the request was granted, which we refer to as G_{i,j,r,x}. G_{i,j,r,x}=<ArchiveGrantReservation, <BrokerRequestArchiveSpace, i, j, k, CCK_{i,j}, storage_{i,j,r}, t_{i,j,r,x}, τ_{i,j,r,x}, kₐₓ⁻¹>_{kB}>ₖₐₓ
   b. Deny the request sending B
      <ArchiveDenyReservation, <BrokerRequestArchiveSpace, i, j, k, CCK_{i,j}, storage_{i,j,r}, t_{i,j,r,x}, τ_{i,j,r,x}, kₐₓ⁻¹>_{kB}>ₖₐₓ.
3. In the event of a granted request, both parties will need to log their inbound and outbound messages until the contract implied by the reservation expires. Note that both replies have the original signed request embedded in them.

### 7.2.1 Single Archive Storage Reservation Error Handling and Disputation

Since a correctly working archive may confirm or deny a reservation, so aₓ may make the following errors.
1. Incorrect confirmation or rejection message.
   a. The reply message is malformed (e.g. has the wrong syntax or header).
   b. The reply does not have the correct request message embedded in it. Either the signature will be wrong, or this indicates a replay attack.
   c. The message signature of aₓ is invalid.
2. aₓ fails to reply in a timely manner.

These cases are handled in the normal course of the witness's operation, hence no disputation is possible.

### 7.3 Single Fragment to Single Archive Distribution

For reuse and support of higher level protocols, we define a pushing protocol which distributes a given fragment f_{i,j,k} from the broker B to a given archive aₓ. For correct application of this protocol the following preconditions must be met.
1. The fragment, f_{i,j,k} must be valid (i.e. correctly signed), and already be held by the broker, B.
2. Both the broker, B, and the archive, aₓ, must have previously performed a corresponding successful single archive storage reservation (as per Section 7.2) and have the grant message, denoted G_{i,j,r,x}, archived.
   The broker, B, initiates this protocol and must have the following parameters.
1. A digitally signed fragment of data that aₓ will store, <f_{i,j,k}>_{CCKi,j},
2. The grant message G_{i,j,r,x} and corresponding request parameters contained therein, from the single archive storage reservation protocol (see Section 7.2). In particular, the distribution protocol requires storage_{i,j,r}≧|f_{i,j,k}|.
3. The broker will need to compute D(f_{i,j,k})

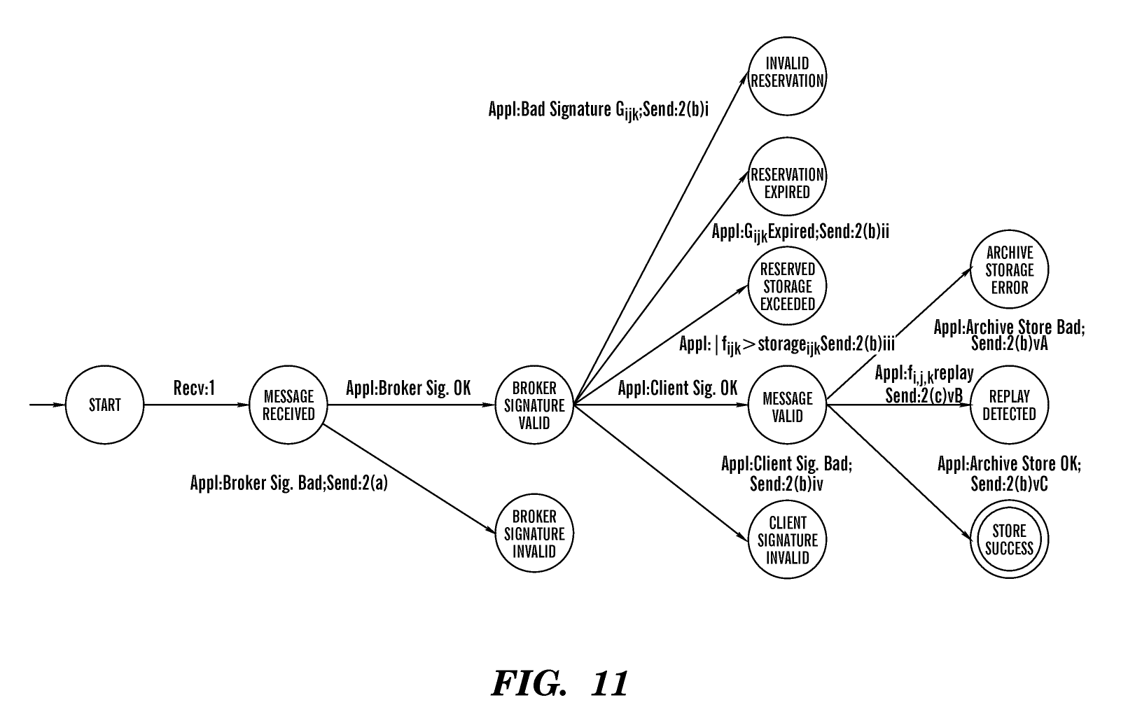

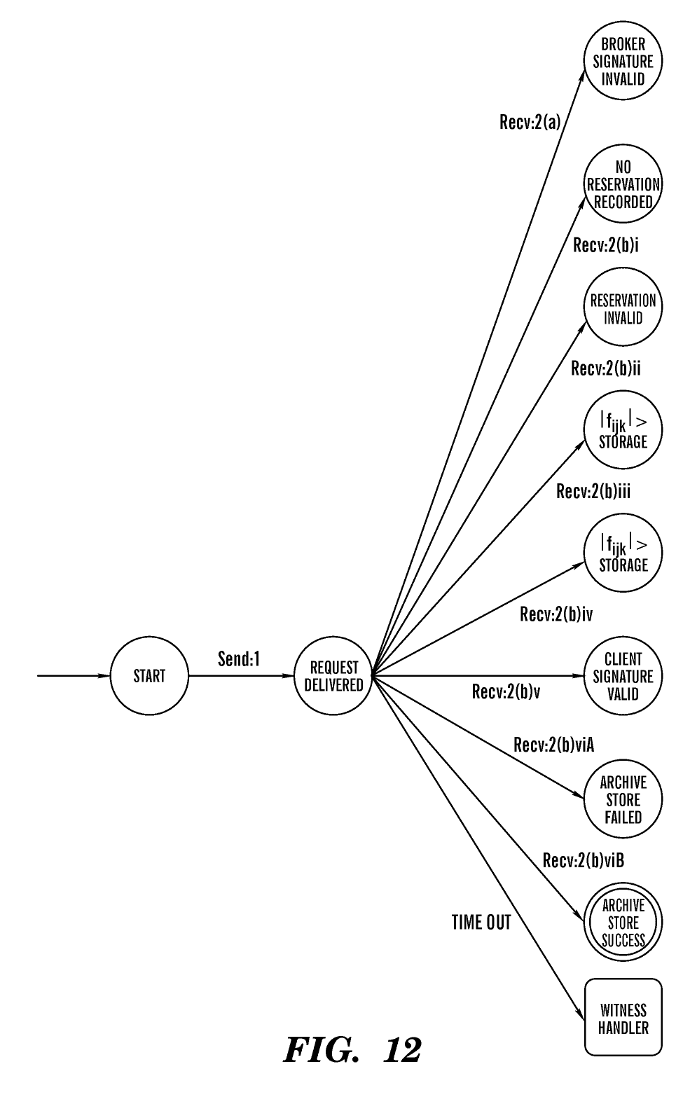

B implements the DFA shown in FIG. 12, while aₓ implements the DFA in FIG. 11, and the protocol operates as follows.
1. B sends a message containing f_{i,j,k} as defined in Equation, i.e. an erasure encoded fragment and associated challenge response lists to aₓ. The sent message, for notational convenience in this section of the document is referred to as M, and we introduce a submessage binding the fragment id, k to the Grant, G_{i,j,r,x}, denoted BrokerBinding_{i,j,k,r,x} where the format BrokerBinding_{i,j,k,r,x}=<G_{i,j,r,x}, k>_{kB} M=<BrokerSendData, BrokerBinding_{i,j,k,r,x}, f_{i,j,k}>_{kB}
2. Upon receipt aₓ checks all signatures in M and G_{i,j,r,x} and examines the fragment identification information, (i, j, k) on each component and one of the following conditions occurs:
   a. If aₓ disputes any of B's signature in M, then aₓ sends B<ArchiveBrokerSignatureIncorrect, i, j, k, M>ₖₐₓ.
   b. Otherwise all of B's signatures match. Exactly one of the following cases must hold:
      i. If G_{i,j,r,x} is not correctly signed by aₓ discards f_{i,j,k} and sends B<ArchiveInvalidReservation, G_{i,j,r,x}>ₖₐₓ.
      ii. The identification tags, i, j, k are not consistent across the fields bf_{i,j,k} and cf_{i,j,k} in f_{i,j,k} and BrokerBinding_{i,j,k,r,x} the archive should reject the request by sending B the message <ArchiveFragmentIDIncorrectTag, M>ₖₐₓ
      iii. If the reservation is expired, then aₓ may discard f_{i,j,k} and sends B<ArchiveReservationExpired, G_{i,j,r,x}>ₖₐₓ
      iv. If |f_{i,j,k}|>storage_{i,j,r}, where storage_{i,j,r} is the amount of storage granted in G_{i,j,r,x}, then aₓ sends B<ArchiveExceedsReservedStorage, i, j, k, M, G_{i,j,r,x}>ₖₐₓ.
      v. If aₓ disputes any of the client's signature of f_{i,j,k} in M, aₓ sends B<ArchiveClientSignatureIncorrect, i, j, k, M, G_{i,j,r,x}>ₖₐₓ.
      vi. Otherwise the received message was well formed, and one of the following cases holds:
         A. aₓ fails (due to an internal error) to successfully store <f_{i,j,k}>_{CCKi,j}, then aₓ indicates failure by sending B the message <ArchiveStoreFailed, i, j, k>ₖₐₓ.
         B. aₓ already has concurrently successfully stored f_{i,j,k}, and this message has a different r number, say r′ (so it is not a retry of a possibly failed send). Let BrokerBinding_{i,j,k,r′,x} denote the value of BrokerBinding_{i,j,k,r,x} for the original store of f_{i,j,k}. In that case, client should send the message <ArchiveStoreReplayRejectedTag, M, M_{original}>ₖₐₓ
         C. aₓ successfully stores f_{i,j,k}, then aₓ sends the message S_{i,j,k,x}=<ArchiveStoreSuccess, BrokerBinding_{i,j,k,r,x}, kₐₓ^{˜1}, D(f_{i,j,k})>ₖₐₓ. where BrokerBinding_{i,j,k,r,x} is defined in equation.

### 7.3.1 Disputation for the Single Fragment to Single Archive Distribution Protocol

In the event of failure, the following cases can arise
1. aₓ indicates it's failure to store the data by sending <ArchiveStoreFailed, G_{i,j,r,x}>ₖₐₓ. No disputation is possible, as aₓ has admitted its own failure.
2. aₓ asserts that the broker's signature on the message is invalid by sending <ArchiveBrokerSignatureIncorrect, M>ₖₐₓ. This requires resolution in slow-mode, since the witness must have a copy of the entire message to diagnose who is at fault, since either party can induce this fault.
3. aₓ asserts that the broker's signature on M is valid, however the client's signature on f_{i,j,k} is invalid by sending <ArchiveClientSignatureIncorrect, G_{i,j,r,x}, M>ₖₐₓ. The witness W will verify the broker's signature on M, and cᵢ's or B's signature on f_{i,j,k}. If the message signature is valid, but f_{i,j,k}'s is not, W will mark B faulty. Otherwise W will mark aₓ faulty.
4. aₓ asserts that M is correctly signed by B but the G_{i,j,r,x} embedded in M is does not have a valid signature (with aₓ's private key kₐₓ). aₓ responds sending <ArchiveInvalidReservation, M>ₖₐₓ to W who can then examine the signatures (since M is signed) and determine with certainty who is at fault.
5. aₓ asserts that all signatures in M are correct, but that B reserved less space than was requested, by sending <ArchiveExceedsReservedStorage, M>ₖₐₓ to W who can then determine the validity by examining the signatures of M and the embedded reservation grant, G_{i,j,r,x}.
6. aₓ indicates that the data arrived after the reservation expired

### 7.4 Many Fragment Push

This protocol requires that the following parameters be given, where:
1. F⊂{f_{i,j,k}|1≦k≦n_{i,j}} denotes the set of fragments to distribute,
2. n=|F| represents the total number of fragments to distribute and
3. 0≦T≦n denotes the threshold minimum number of archived fragments required for successful storage of F.
1. Invite archives to host F with a threshold of T acceptances using the invitation protocol in Section 7.10. If this step fails, the protocol is aborted otherwise the protocol advances to the next step.
2. Invoke the multiple fragment to any invited archive protocol of Section 7.6.

### 7.5 Initial Dissemination

We define a client initiated protocol, that supports distribution of a data object, d_{i,j}, via a broker, B to a set of archives A_{i,j}(t)⊂A(t), and computes an associated fragment to archive mapping FA_{i,j}(t). The protocol proceeds as follows:
1. The client, cᵢ, and broker B negotiate for encoding and storage parameters, including the reconstruction threshold T_{i,j}, via the protocol defined in Section 7.1, and stores G_{i,j} the grant message for the reserved storage for d_{i,j} (see message).
2. Given the storage reservation message and agreed erasure encoding parameters of G_{i,j} from Step 1 and d_{i,j}, the client computes the erasure encoding of d_{i,j}, denoted, e_{i,j,k}=[d_{i,j}]^{m}_{i,j}^{,n}_{i,jk}, 1≦k≦n_{i,j}. It follows from its definition in Section 5.3 via equation that cf_{i,j,k} must be constructed by cᵢ, while f_{i,j,k}'s definition via equation requires B to extend cf_{i,j,k} with <{k_{CRi,j,k,B}}_{kB}⁻¹, {CR_{i,j,k,B}}_{kCRi,j,k,B}>_{kB} Accordingly, cᵢ sends to B <ClientSendData, G_{i,j}, <cf_{i,j,1}>_{CCKi,j}, . . . , <cf_{i,j,ni,j}>_{CCKi,j}>_{CCKi,j}
In some systems that do not tolerate large message sizes, or for environments where fragmenting messages is inconvenient (e.g. messages that span media volumes may be problematic) the client and broker can agree on the following variant of the format: <<ClientSendData, i,j, n_{i,j}, G_{i,j}>_{CCKi,j}, <cf_{i,j,1}>_{CCKi,j}, . . . , <cf_{i,j,ni,j}>_{CCKi,j}> from which B extracts cf_{i,j,k} and performs the above concatenation to form f_{i,j,k}
3. Next, B initializes FA_{i,j}=φ and then attempts to distribute (f_{i,j,1}, f_{i,j,2}, . . . , f_{i,j,n}) to the archives using the distribution protocol defined in Section 7.6 with T_{i,j}+1 as the required number of correctly stored fragments for this step to succeed. Exactly one of the following will occur:
   a. If NonEmptyMapCount(FA_{i,j})>T_{i,j} then B deems the fragment distribution successful
      i. B sends cᵢ the following message holding using ArchiveStoreSuccessMSGSet_{i,j}, defined in Section 7.6. B_{i,j}=<BrokerStoreSuccess, G_{i,j}|ArchiveStoreSuccessMSGSet_{i,j}|, ArchiveStoreSuccessMSGSet_{i,j}>_{kB}.
      ii. The broker sends each archive, aₓ, aₓ∈fa_{i,j,k}(t_{i,j}), 1≦k≦n the message <BrokerStoreCommit, S_{i,j,k,x}>_{kB}, where S_{i,j,k,x}∈ArchiveStoreSuccessMSGSet_{i,j}. A correct archive will reply to this message with: <ArchiveAckStoreCommit, <BrokerStoreCommit, S_{i,j,k,x}>_{kB}>ₖₐₓ.
   b. Otherwise, if NonEmptyMapCount(FA_{i,j})≦T_{i,j}, then the archival failed, and the broker does the following:
      i. Sends the client <BrokerStoreFailed, i, j, k, n_{i,j}, m_{i,j}, t_{i,j}, τ_{i,j}>_{kB}
      ii. Sends each archive aₓ, aₓ∈fa_{i,j,k}(t_{i,j}), 1≦k≦n_{i,j} an abort message allowing them to reclaim their resources. <BrokerStoreAbort, i, j, k, n_{i,j}, m_{i,j}, t_{i,j}, τ_{i,j}>_{kB}.

### 7.6 Multiple Fragment to any Invited Archive Distribution

In the course of initial distribution and fragment reconstruction we desire to disseminate the maximum number of unique fragments to distinct servers as possible. Accordingly we define a protocol which accepts a set of fragments, which for the duration of this section, we will denote as F, F⊂{f_{i,j,k}|1≦k≦n_{i,j}}, a minimum availability threshold T_{i,j} such that T_{i,j}≦|F|, and a set of invitation acceptances Invited_{i,j}, |Invited_{i,j}|≧|F|. It attempts to distribute each fragment to at least one archive, not hosting other fragments of d_{i,j} and returns the following:
1. the fragment to archive mapping of successfully disseminated fragments, denoted for the remainder of this section as FA′_{i,j} and
2. the set of messages returned by the archives indicating successful storage of fragment f_{i,j,k} on archive aₓ, denoted ArchiveStoreSuccessMSGSet_{i,j}.
   The protocol functions as follows.
1. While (F≠φ)Λ(Invited_{i,j}≠φ)Λ(|Invited_{i,j})≧(Tᵢⱼ^{˜}−|FA′_{i,j}) do the following steps
   a. Select f_{i,j,k} such that f_{i,j,k}∈F
   b. Select an invitation response r from Invited_{i,j} and set Invited_{i,j}=Invited_{i,j}−r. Let aₓ be the archive that sent r
   c. Attempt to transmit the fragment f_{i,j,k} to aₓ utilizing the protocol defined in Section 7.3
   d. If the protocol in the previous step has succeeded, B does the updates the following values.

FA′_{i,j}=FA′_{i,j}␣(k,aₓ)
ArchiveStoreSuccessMSGSet_{i,j}=ArchiveStoreSuccessMSGSet_{i,j}∀{S_{i,j,k,x}}

F=F−{f_{i,j,k}}
2. Exactly one of the following cases will occur.
   a. If NonEmptyMapCount(FA′_{i,j})≦T_{i,j} then B notifies all archives to abort the protocol and cancels the distribution
   b. otherwise, B sends confirmation to all archives, updates the fragment to archive mapping FA_{i,j}=FA_{i,j}␣FA′_{i,j} and sends abort messages to all archvies with unused invitations.

### 7.7 Challenge-Response Integrity Check For Client or Broker

This protocol could be performed either by the client or the broker, B, here we give the broker variant. As a precondition, f_{i,j,k} must have been correctly stored on archive aₓ via the single fragment to single archive distribution protocol of Section 7.3. B must have CR_{i,j,k,B} which it uses to determine
1. the challenge (L_{i,j,k,y}, U_{i,j,k,y}, N_{i,j,k,y}) where 0≦y≦C_{i,j,k} and
2. the precomputed expected response, ExpectedResponse_{i,j,k,y}=D(DataInterval(F(e_{i,j,k}, N_{i,j,k,y}) L_{i,j,k,y},U_{i,j,k,y})).

In addition to the requirements for the challenge-response protocol, to prevail in any potential disputes, the challenger should possess the signed message, S_{i,j,k,x}, from the archive indicating successful storage of f_{i,j,k}, defined as message, see Section 7.3.

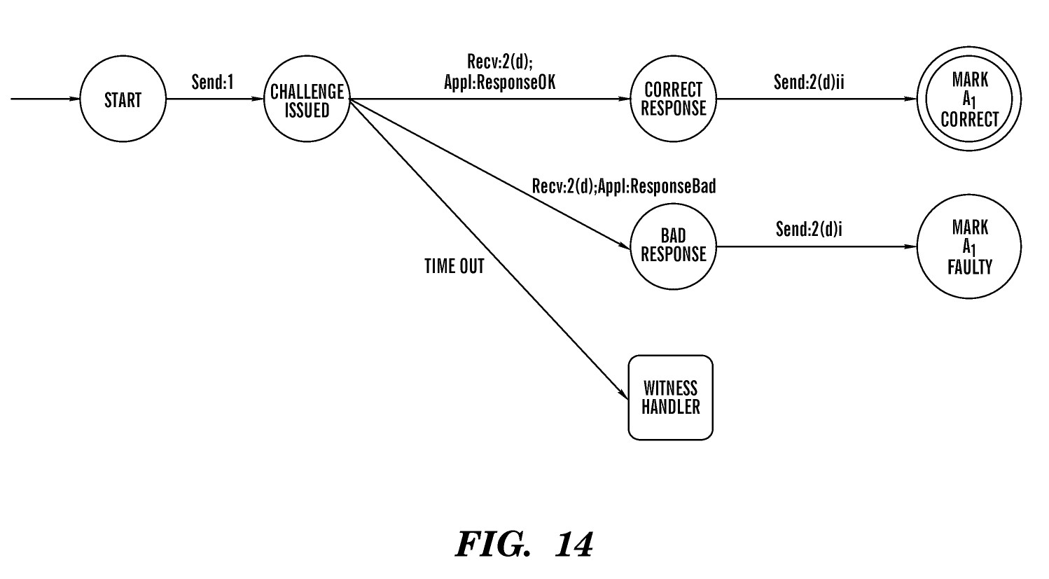

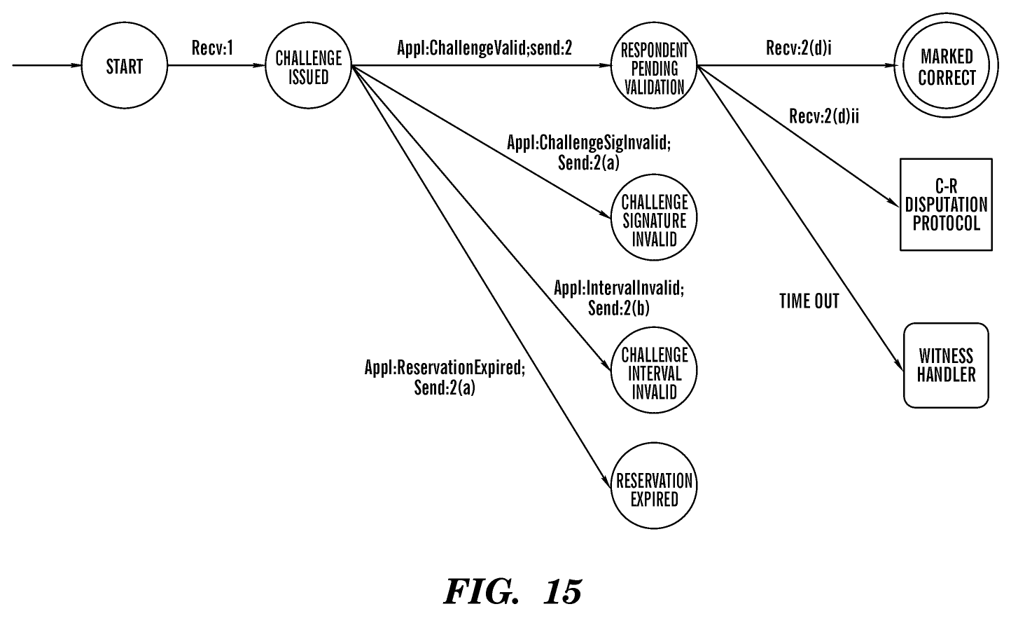

The broker's challenge response protocol has the DFA as shown in FIG. 14, while the Archive has the DFA seen in FIG. 15, and the protocol proceeds as follows. $
1. B sends the archive currently hosting e_{i,j,k}, aₓ∈fa_{i,j,k}(t), the message, which we will call C for notational convenience, where C=<Challenge, S_{i,j,k,x}, L_{i,j,k,y}, U_{i,j,k,y}>_{kB}.
2. Upon receipt aₓ will verify the challenge is well formed as follows
   a. if the signatures on S_{i,j,k,x} are invalid, aₓ immediately complains by sending <ArchiveChallengeSignatureInvalidTag, C>ₖₐₓ.
   b. if S_{i,j,k,x} is expired
   c. otherwise the signatures on S_{i,j,k,x} are valid and S_{i,j,k,x} is not expired, then aₓ checks that 0≦L_{i,j,k,y}≦U_{i,j,k,y}<|e_{i,j,k}|. If not, then aₓ complains that the challenge specified an invalid interval by sending <ArchiveChallengeIntervalInvalidTag, C>ₖₐₓ
   d. Upon receipt of a valid message, C, aₓ will send a response, which for notational convenience, we will call R, with an embedded copy of the signed challenge, where R=<Response, <Challenge, S_{i,j,k,x}, L_{i,j,k,y}, U_{i,j,k,y}>k_{B},Response_{i,j,k,y}>ₖₐₓ. Exactly one of following scenarios will occur20:
      i. ExpectedResponse_{i,j,k,y}≠Response_{i,j,k,y}, B labels aₓ as failed and sends a complaint
         <ArchiveIntegrityFailed, aₓ, R>_{kB} advertising the failure to Wand the client
      ii. Response_{i,j,k,y}=ExpectedResponse_{i,j,k,y}, B labels aₓ as correct and sends the message
         <ArchiveIntegrityVerified, aₓ, R>_{kB} to W
      iii. A faulty aₓ will timeout and the witness, W will detect non-responsiveness.

### 7.7.1 Error Disputation For The Challenge-Response Protocol

An archive aₓ wishing to dispute an allegation of integrity failure may send the following message to W, thereby producing the signed e_{i,j,k}<DisputeArchiveIntegrityFailed, <ArchiveIntegrityFailed, aₓ, R>_{kB}>ₖₐₓ Let the plaintiff be defined as the entity performing the challenge (either B or cᵢ) and the defendant denote the accused archive, aₓ. If the defendant produces e_{i,j,k} then by definition a well formed e_{i,j,k} contains a valid signature by cᵢ. W shall compute from e_{i,j,k} the proper response to the challenge given by the plaintiff, and following cases can occur.
1. The e_{i,j,k} produced lacks a valid signature. If this occurs the witness marks aₓ faulty.
2. The e_{i,j,k} produced has a valid signature, but the plaintiffs challenge/response pair is invalid (either the response doesn't match the data, or the challenge is based on non-existent intervals). In this case W marks the plaintiff faulty.
3. The e_{i,j,k} produced contains a valid signature, and the plaintiffs challenge response pair is valid. There are two possibilities:
   a. aₓ's response does not match the Ws expected response, so W marks aₓ faulty.
   b. aₓ's response matches W's expected response, so W marks B as faulty.

### 7.8 Retrieve Challenge-Response List Protocol

This protocol can be initiated by either the broker, B or the client cᵢ to get the challenge response list for a fragment, f_{i,j,k}, from some archive hosting f_{i,j,k}, aₓ where aₓ∈fa_{i,j,k}. In the example, we use the broker, B as the initiator, but the client could also initiate the call (either using the broker as a prox or by directly interacting with the client).
1. The broker,B, issues a request for its challenge response list. <RetrieveChallengeResponseList, i, j, k, B>_{kB}. (If the client is testing B would be replaced with cᵢ in all communications)
2. A correct archive, aₓ replies <SendChallengeResponseList, i, j, k, B, <{k_{CRi,j,k,B}}_{kB}⁻¹, {CR_{i,j,k,B}}_{kCRi,j,k,B}>_{kB}>ₖₐₓ.
3. If aₓ fails to respond, B labels aₓ faulty as per Section 6.3.3.

### 7.9 Challenge-Response List Replacement Protocol

A challenge response list of a fragment possessing a valid signature can be considered compromised under the following situations.
1. The list contains no remaining unused nonces. This can occur if the backup duration has been extended or the testing interval was shortened.
2. No signed copies of the challenge response list exist.
3. The entity that generated the challenge response list no longer participates in the storage of the fragment (I.E. the client has switched brokers)

In either of these cases it would be wasteful to force regeneration of the fragment. Accordingly we present the mechanism to replace a challenge response list that can be utilized by either the client or the broker. For notational convenience we show the protocol using the broker as the replacing entity. With the exception of the keys used, and the error reported on signature verification failure (ArchiveClientSignatureFailed is sent instead), the protocol is identical for the client.
1. If B does not already possess a correctly signed copy of the fragment it requests the fragment e_{i,j,k} from some aₓ∈fa_{i,j,k} per Section 7.15. (Note: The retrieval protocol verifies cᵢ's signature on the fragment).
2. B generates a new challenge response list CR_{i,j,k,B} according to Section 7.7 with τ_{i,j,r,x} replaced by the remaining backup duration.
3. B multicasts the message <BrokerCRLReplace, i, j, k, <{k_{CRi,j,k,B}}_{kB}^{˜1}, {CR_{i,j,k,B}}_{kCRi,j,k,B}>_{kB}>_{kB} to all aₓ∈fa_{i,j,k}. Let bm represent such a message.
4. A correctly functioning aₓ∈fa_{i,j,k} will verify the signatures on the replacement list and if correctly signed, will both store CR_{i,j,k,B} and will reply with <ArchiveCRLReplaced, i, j, k>ₖₐₓ. Otherwise, the signature is deemed invalid and aₓ will send <ArchiveBrokerSignatureFailed, i, j, k, bm>ₖₐₓ to W. Incorrectly functioning archives with either fail to respond at all (which will be detected in the normal course of W's operation) or send <ArchiveCRLReplaceFailed, i, j, k>ₖₐₓ. Let am denote such a message. B will then send <BrokerArchiveCRLReplaceFailed, i, j, k, am>_{kB} to W.

### 7.9.1 Challenge-Response List Replacement Protocol Disputation

The fragment retrieval protocol of Section 7.17 employs the disputation resolution techniques of Section 7.17.1. The remaining disputable issues in the challenge response list replacement protocol thus occur in the subsequent steps, as follows:
1. Recall that failure to acknowledge message delivery via an ack will time out and be detected by W.
2. Creation of the challenge response list in step 2 is self initiated by B and thus is not disputable.
3. If any recipient of the multicast in step 3 fails to respond, this will be detected by W.
4. If in step 4 the following allegations could be made.
   a. An archive aₓ could consider the new list, CR_{i,j,k,B}, as incorrectly signed, W will test the signature for integrity to resolve this dispute. A well formed signature results in adjudication against aₓ otherwise B will be labeled faulty, as in Section 6.3.3.
   b. B can assert an archive aₓ has indicated its failure to store the list. If the signature on aₓ's message is valid W marks archive failed. Otherwise W marks B faulty.

### 7.10 Multiple Archive Invitation

As both reconstruction of lost fragments, and initial distribution require successful invitation of a set number of archives, we define a helper protocol which requires as parameters the minimum number of invitation acceptances required for success (minᵢₙᵥᵢₜₑₛ), the desired number of acceptances (n_{i,j}), the client identifier (i), the backup identifier (j), the estimated delivery date of the data (t_{i,j}), the size of an individual fragment and accompanying challenge response lists (|f_{i,j,k}|), and the backup duration (τ_{i,j}). It either returns a set of archives of at least size minᵢₙᵥᵢₜₑₛ, or reports failure. This protocol is only executed by the broker, B.
1. If it has not already done so, B consults the results of past distributions (i.e. invitation acceptance rate and storage success) and its estimates of remaining storage capacity of all registered working archives at the time of archival, A(t_{i,j}) and determines the set of archives it will invite to store d_{i,j}, Invited_{i,j}, |Invited_{i,j}|≧n_{i,j}. During the execution of the algorithm, at each iteration exactly one of the following cases will occur.
   a. If (Invited_{i,j}≠φ)Λ(|Accepted|<minᵢₙᵥᵢₜₑₛ) then do the following.
      i. Let RSVP⊂Invited_{i,j}, |RSVP|=max((n_{i,j}−|Accepted|), |Invited|). B sets Invited_{i,j}=Invited_{i,j}^{˜}RSVP. For each aₓ∈RSVP B, using the protocol defined in Section 7.2, requests that aₓ reserve storage.
      ii. Let r represent aₓ's response the invitation. If aₓ accepts then B sets Accepted=Accepted∪r, else it proceeds to the next such aₓ.
   b. Otherwise one of the following two cases must hold:
      i. |Accepted|≧minᵢₙᵥᵢₜₑₛ and the protocol terminates, returning Accepted(t_{i,j})
         A. |Accepted|<minᵢₙᵥᵢₜₑₛ, implying there are too few archives willing to host the fragments. B sends to each aₓ∈A_{i,j}(t_{i,j})<BrokerRequestArchiveSpaceAbort, i, j, k, |f_{i,j,k}|, t_{i,j}, τ_{i,j}>_{kB} A correct aₓ will respond with <RequestArchiveSpaceAbortConfirmed, i, j, k, |f_{i,j,k}|, t_{i,j}, τ_{i,j}>ₖₐₓ
         B. B returns φ

### 7.11 Broker Based Fragment Redistribution

Recall the fragment to archive mapping FA_{i,j}(t), from definition 5.1,

FA_{i,j}(t)={(k,fa_{i,j,k}(t))|1≦k≦n_{i,j}Λfa_{i,j,k}(t)⊂A_{i,j}(t)}, Where 1≦k≦n_{i,j} identifies the fragment f_{i,j,k} and fa_{i,j,k}(t)⊂A_{i,j}(t) denotes the set of archives hosting fragment f_{i,j,k}. Recall that the initial value of FA_{i,j}(t₀) is computed in Section 7.5. Consider two times, tₕ, tₕ₊₁ where tₕ<tₕ₊₁ and how FA_{i,j} evolves. Some fragments will no longer reside on the same archives at time tₕ₊₁ as at time tₕ, we denote this set of removed mappings as RA_{i,j}(tₕ₊₁) while some fragments will be placed on new archives, we denote these new mappings as NA_{i,j}(tₕ₊₁). More formally:

$${FA}_{i , j} ( {t}_{h} + 1 ) = {( {FA}_{i , j} ( {t}_{h} ) - {RA}_{i , j} ( {t}_{h + 1} ) )}_{⊔} {NA}_{i , j} ( {t}_{h + 1} )$$

$$\begin{matrix}{RA}_{i , j} ( {t}_{h + 1} ) = {FA}_{i , j} ( {t}_{i} ) - {FA}_{i , j} ( {t}_{h + 1} ) \\ = \{ \begin{matrix}( k , {ra}_{i , j , k} ( {t}_{h + 1} ) ) \vert ( 1 \leq k \leq {n}_{i , j} ) \\ ( {ra}_{i , j , k} ( {t}_{h + 1} ) ⊆ {A}_{i , j} ( t\_h )\end{matrix} \}\end{matrix}$$

$$\begin{matrix}{NA}_{i , j} ( {t}_{h + 1} ) = {FA}_{i , j } ( {t}_{h + 1} ) - {FA}_{i , j} ( {t}_{i } ) \\ = \{ \begin{matrix}( k , {na}_{i , j , k} ( {t}_{h + 1} ) ) \vert ( 1 \leq k \leq {n}_{i , j} ) \\ ( {na}_{i , j , k} ( {t}_{h + 1} ) ⊆ {A}_{i , j} ( {t}_{h + 1} ) )\end{matrix} \}\end{matrix}$$

It follows that for any k, if (k, na_{i,j,k})∉NA_{i,j} then fa_{i,j,k}(tₕ)⊃fa_{i,j,k}(tₕ₊₁)
This protocol has the following post-conditions for FA_{i,j}(tₕ₊₁) given FA_{i,j}(tₕ).
1. A missing fragment remains missing (barring a fragment reconstruction as seen in Section 7.12), i.e. if fa_{i,j,k}(tₕ)=φ then fa_{i,j,k}(tₕ₊₁)=φ.
2. Under correct behavior, at least one copy of every existing fragment should be retained, i.e. if fa_{i,j,k}(tₕ)≠φ then fa_{i,j,k}(tₕ₊₁)≠φ.
   Given the above we define the redistribution protocol as follows.
1. The broker, B, computes the desired change sets NA′i,j(tₕ₊₁) and RA′i,j(tₕ₊₁).
2. If NA_{i,j}(tₕ₊₁)≠φ,
   a. ∀(k, na_{i,j,k}(tₕ₊₁))∈NA_{i,j}(tₕ₊₁) B requests the fragment from any archive a∈fa_{i,j,k}(tₕ) in the same manner as it would if it were utilizing a in a restore, a 1a Section 7.17 and Section 7.17.1. If B considers a faulty B temporarily (or permanently if the dispute process has completed) removes a from fa_{i,j,k}(tₕ) and repeats the restore attempt. If fa_{i,j,k}(tₕ)=φ, B removes (k, na_{i,j,k}(tₕ₊₁)) from NA_{i,j}(tₕ₊₁), and if fa_{i,j,k}(tₕ)−ra_{i,j,k}(tₕ₊₁)=φ removes it from RA_{i,j}(tₕ₊₁) as well.
   b. B proceeds to distribute the retrieved blocks to the new archives na_{i,j,k}(tₕ₊₁), (k,na_{i,j,k}(tₕ₊₁))∈NA_{i,j}(tₕ₊₁) per the invitation and distribution stages of the protocol given in Section 7.5, except
      i. minᵢₙᵥᵢₜₑₛ=min_{distributions}=␣_{1≦k≦n}⊂na_{i,j,k}(tₕ₊₁)⊂
      ii. τ_{i,j}=tₕ₊₁ tₕ in the normal case, or a broker defined value if the shift is only temporary (i.e. an archive is performing maintenance and negotiates with the broker to temporarily migrate fragments to another host).
3. B notifies cᵢ of the archive set change via the message <BrokerArchiveSetChange, i, j, NA_{i,j}(tₕ₊₁), RA_{i,j}(tₕ₊₁)>_{kB}
4. Client cᵢ computes FA_{i,j}(tₕ₊₁)=(FA_{i,j}(tₕ)^{˜}RA_{i,j}(tₕ₊₁))␣NA_{i,j}(tₕ₊₁).
5. cᵢ performs a challenge-response data integrity check for each unique [d_{i,j}]^{m}_{i,j}^{,n}_{i,jk} held by FA_{i,j}(tₕ₊₁), by selecting one archive from fa_{i,j,k}(tₕ₊₁) to perform the challenge on.
6. cᵢ notifies B of the results of the challenge-response protocol
7. If cᵢ gets at least m_{i,j} correct responses
   a. For each r∈ra_{i,j,k}(tₕ₊₁), cᵢ transmits to B a time-stamped signed message of the form <ClientAuthorizeFragmentDelete, i, j, k, r>_{CCKi,j}) authorizing r to remove f_{i,j,k}. Let ClientAuthorization represent such a message.
   b. For each r∈ra_{i,j,k}(tₕ₊₁), B transmits to r a message of the form <BrokerArchiveDeleteFragmentTag, i, j, k, r, ClientAuthorization>_{kB}.
   c. A non-faulty archive server receiving such a message will send a signed acknowledgment to B of the form <ArchiveFragmentDeleted, i,j,k>ₖₐₓ B will send <BrokerFragmentDeleted, i, j, k, r>_{kB} if it succeeds in updating it's mapping and <BrokerMappingUpdateFail, i, j, k, r>_{kB} if it can not. If this occurs let M represent the broker's failure message. cᵢ will send <ClientBrokerMappingUpdateFail, i, j, k, M>_{CCK} to W

### 7.11.1 Error Disputation For The Redistribution Protocol

This protocol is a composite of the restore protocol and the distribution protocol, with a deletion acknowledgement at the end. Failure to delete a fragment by an archive does not harm availability. Accordingly, the only type of complaint that can reasonably be lodged is that of non-responsiveness, which is caught by the witness W. Additionally, if B encounters an error updating its mapping or does not respond, no disputation is possible as either B has freely admitted its fault, or W has already noted non-response. Therefore please refer to Sections 7.17.1 and 7.5.2 for the respective disputation processes of restore and distribution.

### 7.12 Broker Based Reconstruction of Fragments Lost due to Archive Faults

When the number of lost fragments begins to approach the minimum availability tolerance of the broker, B, it is advisable to replace the fragments which have been lost or damaged. As the broker, B is the single point of contact with the archives (the client routes all requests through it), the broker should perform this duty. However, the client must be assured that the fragments the broker generates are compatible with the original encoding. Thus, our method requires the use of a deterministic erasure encoding such that given all parameters to that encoding, repeating the erasure encoding d_{i,j} will result in identical fragments to a prior encoding. For efficiency in reconstruction, we want the broker to retain both the client communication key generated signature, SignatureOf(cf_{i,j,k}, CCK_{i,j}) and the signed encrypted challenge response lists with their session keys defined in and, i.e. <{k_{CRi,j,k,ci}}_{CCKi,j}^{˜1}, {CR_{i,j,k,ci}}_{kCRi,j,k,ci}>_{CCKi,j} and <{k_{CRi,j,k,B}}_{kB}^{˜1}, {CR_{i,j,k,B}}_{kCRi,j,k,B}>_{kB}.

Recall that the client stored all parameters to the encoding, and the root node of the erasure coded data object's hash tree with the fragment. Using this the following actions are performed
1. B reconstructs all unavailable fragments as follows. In the case of Tornado encoding, we employ the heuristic given in Section 7.12.1.
   a. B determines the set of fragments that need replacing, either by performing a challenge/response on A_{i,j}(t) or by stored knowledge. These fragments are stored in a set called MissingFragments_{i,j}.
   b. B does the following:
      i. Determine a set of fragments ReconstructionInputs_{i,j}(MissingFragments_{i,j}) suitable for reconstructing MissingFragments_{i,j}. Note there may be many sets of available fragments that satisfy this criteria, normally a good candidate has a low retrieval cost.
         Let UnretrievedFragments_{i,j}(MissingFragments_{i,j}) denote the subset of unretrieved fragments in ReconstructionInputs_{i,j}.
      ii. For each fragment e_{i,j,k}∈ReconstructionInputs_{i,j}(MissingFragments_{i,j}).
         A. B attempts to retrieve e_{i,j,k} from some archive aₓ∈fa_{i,j,k} using the protocol in Section 7.14, and does the following depending on the outcome.
         B. If the retrieval is successful then UnretrievedFragments_{i,j}(MissingFragments_{i,j})=UnretrievedFragments_{i,j}(MissingFragments_{i,j})−{e_{i,j,k}}.
         C. If the retrieval fails then fa_{i,j,k}=fa_{i,j,k}−aₓ, and one of the following cases must occur
         If fa_{i,j,k}=φ then MissingFragments_{i,j}=MissingFragments_{i,j}∪e_{i,j,k} and the algorithm is restarted at Step 1(b)i.
         Otherwise, the algorithm retries Step 1(b)iiA
   c. From one of the retrieved fragments B extracts the encoding parameters the client used, then erasure encodes all e_{i,j,k}∈MissingFragments_{i,j} If cᵢ has correctly stored the parameters in the fragments, then the resulting in |MissingFragments_{i,j}|≦n_{i,j}−m_{i,j} fragments will be identical to the originally encoded values.
2. The newly created blocks need to have client and broker side challenge-response lists attached and a correct client signature appended. This can be done as follows:
   a. If B has SignatureOf(cf_{i,j,k}, CCK_{i,j}) and the signed encrypted challenge response lists with their session keys defined in and, i.e. <{k_{CRi,j,k,ci}}_{CCKi,j}^{˜1}, {CR_{i,j,k,ci}}_{kCRi,j,k,ci}>_{CCKi,j} and <{k_{CRi,j,k,B}}_{kB}^{˜1}, {CR_{i,j,k,B}}_{kCRi,j,k,B}>_{kB}. Then B reconstructs f_{i,j,k} by concatenation as per the definition in. Since these will tend to be small, B can be expected to store many of them.
   b. Otherwise B forwards the reconstructed fragments the set of retrieved blocks to cᵢ and requests cᵢ to generate fresh challenge response lists and a new cryptographic signature. Note that the signatures on the retrieved blocks allow the client to verify the reconstruction. cᵢ returns the now signed blocks to B.
   Approach 2a is preferred since it avoids network traffic and reduces the work done by the client. To improve availability of the required signatures and signed challenge-response lists we note that B can batch and disseminate (either using replication or erasure encoding) these to the archives using a variant of the protocol presented in Section 7.5 in addition to using local storage.
3. Client notification will be needed.
   a. If the protocol succeeds, then the protocol in Section 7.3 is performed24 for each reconstructed fragment, e_{i,j,k}, which both attempts to place e_{i,j,k} on an archive and notifies cᵢ of the updates to the fragment to archive map, FA_{i,j}.
   b. If the protocol fails, then some of cᵢ's data has become unrecoverable, since if d_{i,j} could be reproduced, repeating the initial encoding could have been used to reconstruct all missing blocks. Thus, B sends <BrokerFragmentsLost, MissingFragments_{i,j}, FA_{i,j}>_{kB}. In the event that the client wants partial data, they can initiate recovery of all remaining fragments.

### 7.12.1 A Heuristic for Lost Fragment Reconstruction Protocol Using Tornado Codes

Below we give an optimized variant of the protocol suitable for tornado codes. In tornado codes, erasure encode fragments either contain user data, or are check blocks derived from XORs of data blocks or check blocks. The encoding uses a tornado graph to indicate which blocks are XORed together to generate a check block. To provide improved resilience we assume that the broker, B, knows the tornado graph, and knows the set of correct archives via a recent challenge response protocol. Note that due to dependencies in the tornado code check fragment construction, their may be constraints on the order of reconstruction. For clarity, we will refer to fragments residing on the broker, B as retrieved, fragments that are either retrieved or residing on a correctly functioning archives as available, while any fragment specified by the erasure encoding is said to exist. An estimate of availability of fragments is obtained via a recent challenge-response integrity test of the archives. Note that a fragment may exist and be unavailable (i.e. needing reconstruction). For this algorithm, the broker, B will keep a set MissingFragments that contains the fragment identifiers of all missing fragments. Prior to reconstruction, the broker computes the reconstruction schedule and retrieves only the missing fragments. We refer to a fragment used to construct a check fragment as a child of the check fragment and refer to the check fragment as a parent of the fragment. The lost fragment reconstruction algorithm for Tornado codes goes as follows:
1. Assign−OldMissingFragments=MissingFragments−.
2. For each missing fragment e_{i,j,k}, such that k∈MissingFragments the broker, B, attempts reconstruction as follows:
   a. If e_{i,j,k} is an unavailable data fragment, tornado codes require what we will call “a candidate check fragment” that has (with the exception of the fragment we are trying to reconstruct) all of the data fragments used in its construction. The following cases can occur:
      i. No candidate check blocks exist, in which case e_{i,j,k}'s reconstruction is postponed until an available candidate fragment exists.
      ii. Some available candidates exist. The broker selects the candidate requiring the minimum number of unretrieved data fragments and invokes the fragment retrieval algorithm for the check fragment and data fragments. The following cases could occur:
         A. Retrieval fails for some of the requested fragments, in which case those fragments are added to the MissingFragments set and reconstruction of this fragment is postponed.
         B. All requested fragments are successfully retrieved, and are XOR-ed together producing e_{i,j,k}.
      iii. Some candidate fragments exist, however all of the existing candidate fragments are unavailable. The reconstruction of e_{i,j,k} will be postponed until a candidate fragment is available.
   b. If e_{i,j,k} is an unavailable check fragment, then B estimates the feasibility and cost of reconstruction (in terms of number of blocks needing retrieval). The following conditions are checked and costs are estimated.
      i. If the check block is not part of the “double heavy tails,” that is the final two levels of check blocks serve as checks on the antepenultimate level, then if some available candidate check blocks exist for e_{i,j,k}, then identify the available candidate check block, e_{i,j,x}, 1≦x≦n_{i,j} with the minimum number of available unretrieved children.
      ii. If all of the children of e_{i,j,k} are available, then it can be constructed by XOR-ing them together (as is done when doing the erasure encoding).
   The following cases can then occur:
      iii. Both conditions 2(b) i and 2(b) ii hold, chose the condition with least cost and attempt retrieval of unretrieved but required fragments. The following cases can occur:
         A. Retrieval fails for some of the requested fragments, in which case those fragments are added to the MissingFragments set and reconstruction of this fragment is postponed.
         B. All requested fragments are successfully retrieved, and are XOR-ed together producing e_{i,j,k}.
      iv. Exactly one of conditions 2(b) i and 2(b) ii holds, attempt retrieval of any unretrieved but required fragments. Again the following cases can occur.
         A. Retrieval fails for some of the requested fragments, in which case those fragments are added to the MissingFragments set and reconstruction of this fragment is postponed.
         B. All requested fragments are successfully retrieved, and are XOR-ed together producing e_{i,j,k}.
      v. Neither condition 2(b)i nor condition 2(b)ii holds, so the reconstruction of e_{i,j,k} is postponed.
3. Exactly one of the following conditions must hold:
   a. If MissingFragments=φ all fragments have been successfully reconstructed, and the algorithm terminates.
   b. Otherwise, if MissingFragments≠OldMissingFragments, there remain potentially reconstructable missing fragments, so restart the algorithm at Step 1
   c. Otherwise, MissingFragments=OldMissingFragments≠φ, and the algorithm can no longer make progress reconstructing fragments, terminate with failure.
      7.13 Retrieval of Backup Identifier Set from The Broker

In the event of catastrophic data loss, the client, cᵢ might lose track of which data objects are stored on broker, B, in which case cᵢ should be able get the set of storage agreements currently in force from B. More formally, a storage agreement is current if and only if:
1. B sent a BrokerStoreSuccess message to cᵢ, as defined in equation in Section 7.5, and
2. The grant on storage G_{i,j} as defined in Section 7.1 must not be expired at the time of receipt of the clients request.
   The protocol proceeds as follows:
1. cᵢ sends B the (timestamped) message M=<ClientRetrieveIDSet, i>_{CCKi,j}
2. B (if correct) will compute J={j⊂B has a currently in force storage agreement for d_{i,j}} and transmit to cᵢ, which for the rest of this section we will note as R, R=<BrokerIDSet, M, J>_{kB}
   7.13.1 Disputation of Retrieval of Backup Identifier Set from the Broker
   The following errors could occur during when running this protocol.
1. The broker could return an incorrect backup identifier set, J, meaning at least one of the following conditions could occur.
   a. ∃j∈J such that d_{i,j} is not currently active on B, cᵢ can immediately request a restore from B of d_{i,j} and provide <BrokerIDSet, M, J>_{kB} as proof that B hosts d_{i,j}, which B would have to forge, which is considered very difficult with a high degree of probability, so B has a strong disincentive to do this.
   b. ∃j∉J such that d_{i,j} is currently active on B. Here, cᵢ may be at a disadvantage if it has truly lost all knowledge of what d_{i,j} values are stored on B. Thus, a client may wish to occasionally perform this protocol when it is in complete knowledge of the set of currently active fragments on B (e.g. cᵢ has the storage success messages). It may be that the witness could help here if the witness caches storage success messages for the duration of the backup. In the event that cᵢ detects such an error, it can refute B by computing a set J′={j|d_{i,j} is actively stored on B and j∉J}, and computing the set of broker store success messages of J′, denoted B_{J′}={B_{i,j}|j∈J′} by sending the message: <ClientBrokerOmitsBackupIDSetTag,R, B_{J′}>_{CCKi,j}.
2. The broker fails to respond in a timely fashion, but this is handled by the witness as a time-out condition.
   7.14 Retrieval of a Single Fragment from a Single Archive

Retrieval of a fragment from a specific archive is a primitive operation used in many of our higher level protocols, thus, for reuse we define the following protocol to retrieve e_{i,j,k} from an archive aₓ∈fa_{i,j,k}. For notational convenience only the broker version of the protocol is presented here. The client's version is semantically identical with substitution of the appropriate keys. Given such an aₓ, B, and S_{i,j,k,x}, message indicating successful storage of f_{i,j,k} on aₓ as described in Section 7.3. The protocol is as follows:
1. B sends aₓ a request message, which for notational convenience, for the rest of this protocol we will denote as M, where M=<RequestFragment, S_{i,j,k,x}>_{kB}.
2. One of the following cases will happen upon receipt of M by aₓ,
   a. S_{i,j,k,x} is not signed correctly by aₓ, so aₓ complains; <ArchiveRetrieveInvalidStoreMessage, M>ₖₐₓ.
   b. The storage contract for f_{i,j,k} on aₓ has expired (i.e. τ_{i,j,r,x} has expired), so aₓ responds 25: <ArchiveRetrieveExpiredStorage, M>ₖₐₓ
   c. The request is well formed and not expired, but (due to internal errors) aₓ cannot comply, and confesses sending <ArchiveRetrieveFail, M>ₖₐₓ
   d. Given a well formed and valid request, a correct aₓ will respond with a reply message we will call R for the remainder of this protocol, where R=<ArchiveSendFragment, M, <i,j,k,e_{i,j,k}>_{CCKi,j}>ₖₐₓ. Upon Receiving R, B will do one of the following
      i. If the signature on R is wrong, B ignores it.
      ii. otherwise, if the received version of M contained in R does not match the sent M, B rejects the retrieve with a message: <BrokerArchiveGarbledRetrieveRequest, R>_{kB}
      iii. otherwise, if <i,j,k,e_{i,j,k}>_{CCKi,j} has an incorrect signature, B sends the complaint <BrokerArchiveClientSignatureInvalid, R>_{kB}.
      iv. otherwise, if <i,j,k,e_{i,j,k}>_{CCKi,j} has some i,j, or k value that does not match the i,j or k value in M, and replies <BrokerArchiveRetrievedWrongFragment, R>_{kB}.
      v. otherwise, R is well formed and B replies <BrokerRetrievedFragmentSuccess, M>_{kB}.

### 7.14.1 Error Disputation in Fragment Retrieval

The broker, B will assert archive failure in one of two instances.
1. The archive, aₓ has sent <ArchiveRetrieveFail, i, j, k>ₖₐₓ
2. aₓ fails to respond with data that matches B, or cᵢ's signature.
   In either case aₓ has no ability to dispute the charge, as it has already asserted it's own failure, or assuming aₓ's cryptographically secure signatures, aₓ provably did not return the correct object.
   7.15 Retrieval of Multiple Erasure Encoded Fragments from Multiple Archives

We define a protocol to retrieve several fragments from any correctly functioning archive in the fragment's archive set as a “helper” protocol that B can use. Typically this protocol is expected to be utilized by the restore, change of broker, and data redistribution protocols. Given, retrieve and FA_{i,j}(t), where FA_{i,j}(t)={(1,fa_{i,j,1}(t)), (2,fa_{i,j,2}(t)), . . . , (n_{i,j},fa_{i,j,ni,j}(t)} and retrieve⊂NonEmptyMaps(FA_{i,j}(t)), the retrieve multiple fragments protocol computes a set RetrievedFragmentSet of successfully retrieved fragments. B proceeds as follows.
1. RetrievedFragmentSet=φ
2. ∀k∈retrieve, B selects an archive,aₓ∈fa_{i,j,k} and attempts to retrieve fragment k using the protocol in Section 7.14. Two cases can arise:
   a. B succeeds in retrieving the fragment, e_{i,j,k}, from aₓ, and updates the result to RetrievedFragmentSet=RetrievedFragmentSet∪{e_{i,j,k}}.
   b. B fails in retrieving e_{i,j,k} from aₓ. B then, as specified in Section 7.14, removes aₓ from all fragment to archive mappings via MapDeleteTargetEdges(aₓ). If k∈NonEmptyMaps(FA_{i,j}(t)) repeats the attempt until the fragment is retrieved, or k∉NonEmptyMaps(FA_{i,j}(t)).
3. Return RetrievedFragmentSet

### 7.15.1 Disputation of Retrieval of Erasure Encoded Fragments

As this protocol is an iterative call of the protocol in Section 7.14 no separate disputation cases arise.

7.16 Recovery of d_{i,j}

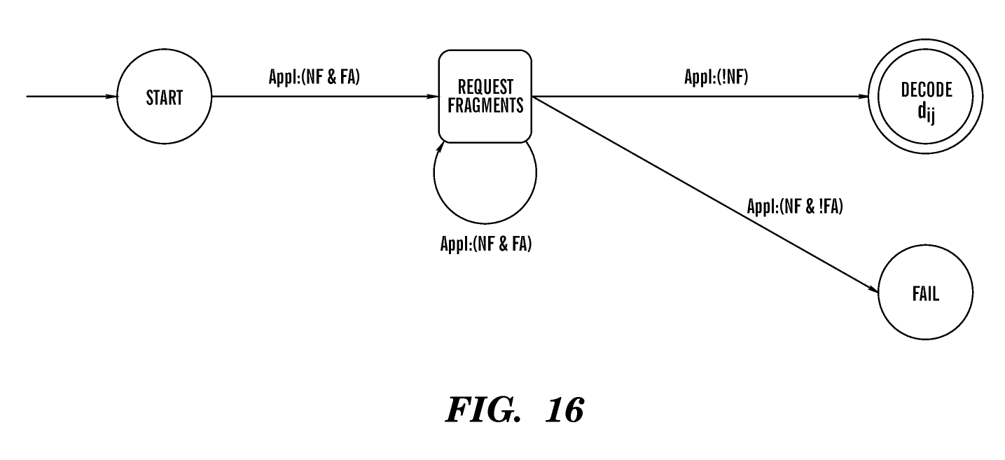

We define a protocol which attempts to recover the data object d_{i,j} from any m_{i,j} fragments. It is expected that the broker's restore protocol, and the fragment reconstruction protocol will make use of it. If the client is acting without a broker's assistance, it would invoke this protocol directly. For notational convenience we present the protocol as performed by the broker. The client's version is identical, with cᵢ and its keys substituting in for B and its keys, and vice-versa. Given m_{i,j}, and FA_{i,j}(t), where m_{i,j} is the d_{i,j}'s reconstruction protocol and FA_{i,j}(t)={(1,fa_{i,j,1}(t)), (2,fa_{i,j,2}(t)), . . . , (n_{i,j}, fa_{i,j,ni,j}(t)}the protocol has the DFA portrayed in FIG. 16 and proceeds as follows.
1. Initialize RetrievedFragmentSet=φ
2. Repeat until |RetrievedFragmentSet|=m_{i,j} or NonEmptyMaps(FA_{i,j}(t))<m_{i,j}
   a. Select m_{i,j}−|RetrievedFragmentSet| fragments from NonEmptyMaps(FA_{i,j}(t))−RetrievedFragmentSet and attempt to retrieve them using the protocol in Section 7.15,
   b. Let retrieved equal the fragments recovered in the previous step, and set RetrievedFragmentSet=RetrievedFragmentSet∪retrieved
3. If NonEmptyMapCount(FA_{i,j}(t))<m_{i,j} the data is irreparably lost. A correct B should abort the protocol and notify cᵢ and W by sending the following message.

<BrokerRestoreFail, i, j>_{kB}
4. Otherwise B recovers d_{i,j}=<<<i, j, CBK_{i,j}^{˜1}, {k_{di,j}}_{CRKi,j}^{˜1}, {p_{i,j}}_{kdi,j}>_{CBKi,j}>_{CRKi,j}>_{CCKi,j} using the algorithm specified in the fragments' metadata, or sends <BrokerClientIncorrectEncode, i, j,Fragments>_{kB} to W.
5. B verifies the client's signature on d_{i,j}. If the signature does not match the broker sends a complaint <BrokerClientSignatureFail, i, j,Fragments>_{kB} to W.
6. At this point we have recovered d_{i,j}

### 7.17 Honoring Restore Requests

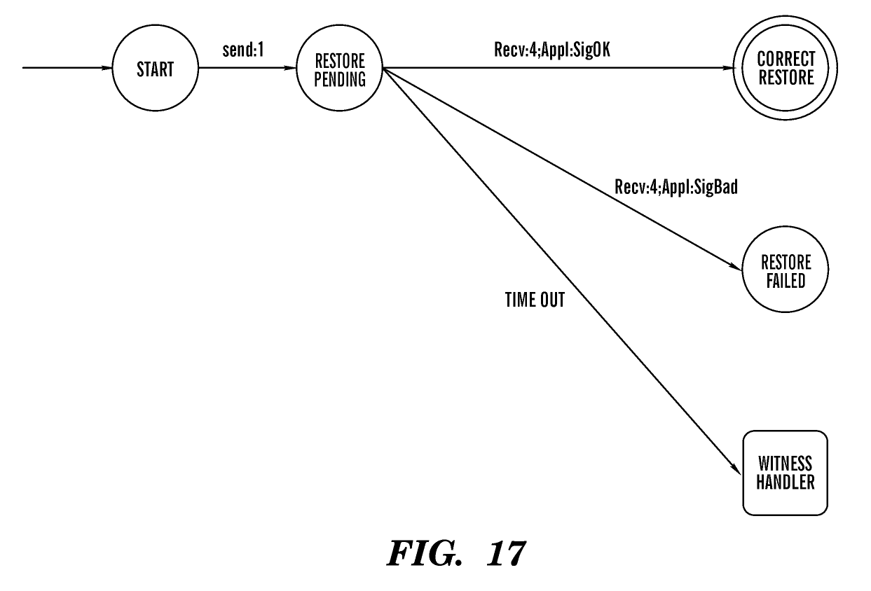

Restores are assumed to be initiated by a client cᵢ that employs a broker B to retrieve the fragments from the set of archives hosting the fragments, A_{i,j}(t). The client side protocol implements the deterministic finite state automaton (DFA) as shown in FIG. 16, while B implements the DFA of FIG. 17.
1. cᵢ notifies the broker B of its intent to restore by sending the message, which for notational convenience, we will denote as M for the remainder of this section, where M=<ClientRequestRestore, i,j>_{CCKi,j} at time tₕ.
2. Given FA_{i,j}(tₕ)={(1,fa_{i,j,1}(t)), (2,fa_{i,j,2}(t)), . . . , (n_{i,j},fa_{i,j,ni,j}t)}, B proceeds as follows.
3. B attempts to recover the data object using the protocol defined in Section 7.16
4. If successful, B, sends d_{i,j} to the client in a format the client can accept using the message <BrokerSendRestoreData, M, d_{i,j}>_{kB}.
5. cᵢ will verify its signature on d_{i,j}. If it matches, restore is successful. If it does not cᵢ will send <ClientBrokerRestoreFail, M>_{CCKi,j} along with the broker signed data to W.

### 7.17.1 Error Disputation For The Restore Protocol

B will assert cᵢ did not correctly encode or sign the data if
1. B cannot extract d_{i,j} from a m_{i,j} signed fragments, f_{i,j,k}
2. B can restore, however the restored data does not match cᵢ's signature on d_{i,j}
   In both cases, cᵢ, to successfully dispute B's assertion W must attempt to recover d_{i,j}. For case one, the success of this operation is sufficient to prove cᵢ's innocence. For the second W must verify cᵢ's signature on d_{i,j}.
   cᵢ will assert broker failure if
1. B sends <BrokerRestoreFail, i,j>_{kB}
2. B sends back a d_{i,j} that does not match the client signature.
   As with archive failure, B has no grounds for disputation as either it asserted it's own failure, or provably returned incorrect data.

### 7.18 Broker Change Protocol

A client, cᵢ, may initiate a change of broker from the original broker B to a new broker B′. A simple but somewhat inefficient mechanism for doing this would be:
1. cᵢ restores d_{i,j} using B as described in Section 7.17.
2. cᵢ performs an initial archive establishment using B′ as defined in Section 7.5.

However, this entails using substantial bandwidth and storage resources of the client and could cause unnecessary data motion in the event that B′ has a similar fragment to archive mapping as B. Thus, for efficiency, we suggest the following protocol28.

Given, a client cᵢ wishing to change its broker from B to B′ for archived data object d_{i,j} with fragment to archive map FA_{i,j}.
1. If cᵢ does not have a current FA_{i,j}, cᵢ requests an update using the mapping request protocol to B as described in Section 7.19. If the map cannot be retrieved, this protocol aborted.
2. The client, cᵢ initiates the protocol sending the new broker, B′, the following message. <<ClientChangeBrokerAuthorization, B′, i, j>_{CCKi,j}, n_{i,j}, m_{i,j}, τ_{i,j,r,x}, FA_{i,j}>_{CCKi,j} If NonEmptyMaps(FA_{i,j})<m_{i,j} then B′ can reject the request as being impossible to fulfill as B′ will not be able to reconstruct d_{i,j}. Accordingly B′ will respond with <BrokerRejectChangeBroker, <ClientChangeBrokerAuthorization, B′, i, j>_{CCKi,j}>_{kB′}
3. For each archive in aₓ∈A_{i,j} the new broker, B′, notifies aₓ of its new role by sending aₓ the following message29. <BrokerChangeInit, <ClientChangeBrokerAuthorization, B′, i,j>_{CCKi,j}>_{kB′} At this point each correct aₓ will perform the following actions.
   a. Prevent B and cᵢ from deleting the fragment until either an abort message is received from B′ or a timeout occurs.
   b. Prevent cᵢ from initiating a change of broker until either an abort or commit is received from B′ or a time out occurs.
   c. Send a confirmation <ArchiveBrokerChangeInit, B′, i, j>ₖₐₓ
4. For all k∈NonEmptyMaps(FA_{i,j}), B′ tries to retrieve one signed copy of each available fragment, <e_{i,j,k}>_{CCKi,j} via the protocol defined in Section 7.15. If B′ cannot retrieve at least m_{i,j} fragments then the protocol aborts, as recovery is not possible. B′ then sends cᵢ the message. <BrokerChangeFailedInsufficientFragmentsTag, i, j>_{kB′}.
5. If NonEmptyMaps(FA_{i,j})≦T_{i,j} then B′ initiates the reconstruction protocol of Section 7.12.
   a. If reconstruction succeeds then B′ marks the regenerated fragments as already posessing a challenge-response list (CR lists are generated as part of the reconstruction protocol), and proceeds to the next step.
   b. Otherwise reconstruction has failed, which causes the broker change to fail, and B′ examines the cause of failure as follows:
      i. If the fragments are incorrectly encoded, B′ sends cᵢ the message <BrokerChangeFailedBadClientEncode, i, j>_{kB′},
      ii. otherwise if B′ failed to disseminate a sufficient number of reconstructed fragments, B′ sends cᵢ the message <BrokerChangeFailedDisseminationError, i, j>_{kB′}
6. For each of the m_{i,j} or more signed fragments, <e_{i,j,k}>_{CCKi,j} that B′ retrieved in step 4, B′ computes a new challenge response list CR_{i,j,k,B′} and a new symmetric session key CR_{i,j,k,B′}, and does the following with each aₓ∈fa_{i,j,k}.
   a. Performs, with aₓ, the challenge-response list replacement protocol detailed in Section 7.9.
   b. Performs a challenge-response integrity check with aₓ, as described in Section 7.7.
7. If the number of nodes correctly responding to challenge response replacement forces NonEmptyMapCount(FA_{i,j})≦T_{i,j} then, a correct B′ should either
   a. Report the data is unable to be hosted by sending <BrokerChangeFailed, i, j>_{kB′}
   b. Repeat step 5 and retry.
   In either case cᵢ shall be able to request the reconstructed data from B′ using the client data transmission portion of the restore protocol specified in Section 7.17.
8. Otherwise the protocol has succeeded, and B′ should send cᵢ the message <BrokerChangeSuccess, i, j, FA_{i,j}>_{kB′}. At this point B′ is responsible for d_{i,j}.

### 7.19 Mapping Request Protocol

For robustness, a protocol is needed to address the case where cᵢ loses the current fragment to archive mapping at time t, FA_{i,j}(t). Such a loss would prevent cᵢ from independently verifying the integrity of its data, changing its broker and restoring its data in the event of broker failure. Accordingly, we define a mapping request protocol in which cᵢ can request a current copy of the mapping from B. We do not, however support B requesting the mapping from cᵢ as we believe that the broker's loss of the mapping is sufficient grounds for broker change and additional penalties may apply. For convenience, in this protocol we introduce the following notation S_{i,j} to represent the set of storage confirmation messages for all fragments of d_{i,j}, i.e.:

S_{i,j}=U_{1≦k≦n}(U_{x fai,j,k}S_{i,j,k,x}) It should also be noted that this protocol can be used to ve$rify the accuracy of the broker's mapping. The protocol is as follows:
1. cᵢ sends, via W, the request <ClientMappingRequest, i, j>_{CCKci} to B.
2. B responds with the mapping and reservation information message, which for notational convenience, for the remainder of this section we will refer to as M_{i,j}, where M_i,j=<BrokerMappingData, i, j, FA_{i,j}, S_{i,j}>_{kB}
3. cᵢ verifies the integrity of the mapping by performing challenge/response integrity checks on each archive defined in the mapping, removing faulty archives from FA_{i,j}(t). If at least m_{i,j} archives each holding distinct f_{i,j,k} respond correctly cᵢ accepts the mapping, else it considers it's data lost and sends <ClientBrokerDataLost, M_{i,j}>_{CCKci} to W.

### 7.19.1 Error Disputation for the Mapping Request Protocol

If B failed to respond with the mapping it will be detected by W in the course of W's normal operation. If, however, an insufficient number of archives will have responded correctly to cᵢ's integrity check W has the records from the integrity tests to refer to. Accordingly, W responds to cᵢ's assertion of data loss by checking those records, and if they support cᵢ considers B faulty and the data lost. If more than m_{i,j} archives holding distinct f_{i,j,k} have responded correctly, W marks cᵢ faulty.

### 8 Client Side Support

Consider the client's archival access requirements. In many environments, it is common for a person trusted with recovering sensitive data to become unavailable or to leave the organization. Additionally, organizations need to manage risk exposures to a potential defector who wants to leak the backed up data. In larger organizations or for sufficiently large risk exposures, distributing trust may be in order. Redistribution of trust must be supported to model evolving responsibilities of people within the organization, and provide defense against mobile attackers. Thus, we define the following system requirements:
1. The writer of archived data should be uniquely identified (authentication).
2. Unauthorized agents should not be able to read archived data in plaintext form.
3. Authorized agents should be able to recover the plaintext of the archived data given the ciphertext.
4. For large organizations and where security concerns merit, trust should not be placed in a single person; rather, the trust should be distributed and consensus should be required for data access.
5. It should be possible to enforce document destruction by making it infeasible to recover the plaintext after the destruction decision has been made (privacy preserving confidentiality).

We use key management as a mechanism for enforcing trust decisions. Distributed trust indicates that we should employ a secret sharing approach which requires consensus among trusted participants to access the shared secret. Additionally, revocation of individual trust, validation of initial shares, and verifiable key redistribution are required to handle when trust evolves over time. Finally, in some cases it may be useful to prevent a faulty (unfaithful) shareholder from submitting a false share in an attempt to prevent reconstruction of the secret. Due to the nature of the archived data as a data communication channel, the key distribution will occur out-of-band.

8.1 Scanning Creation of d_{i,j}

Approaches supporting a pipelined backup process have been explored, by Staubach, and Augustine.

For experimental purposes, we use Linux with ext3fs, and anecdotal evidence appears to show that system administrators like to use variants of dump as a backup tool. Under Linux and Unix, the traditional backup mechanisms include afio, tar and cpio, however in practice we have observed that dump has a faster data transfer rate than these other utilities, since it does not go through the virtual file system (VFS) level. The dd tool can also operate at the raw device level, but has very limited features and is not really designed as a backup tool. Dump is designed to operate at the file system level and has support for incremental backups, making it an ideal choice for backing up an entire file system. Furthermore, dump can operate on unmounted and read-only mounted file systems, while the other tools are designed to operate at the file level and modify the file system attributes.

8.2 File System Scanners and their Limitations

Historically, file system scanners have run separately from the backup process. Consider the famous Tripwire program, which works as follows. When Tripwire is installed, the system administrator runs an initial system scan to create a database of cryptographic hashes (e.g. MD5) and file attributes. This database is then maintained and checked on subsequent scans to determine which files changed. In practice, it may be impractical to perform complete scans regularly (they may take too long and may not complete in a typical overnight cycle).

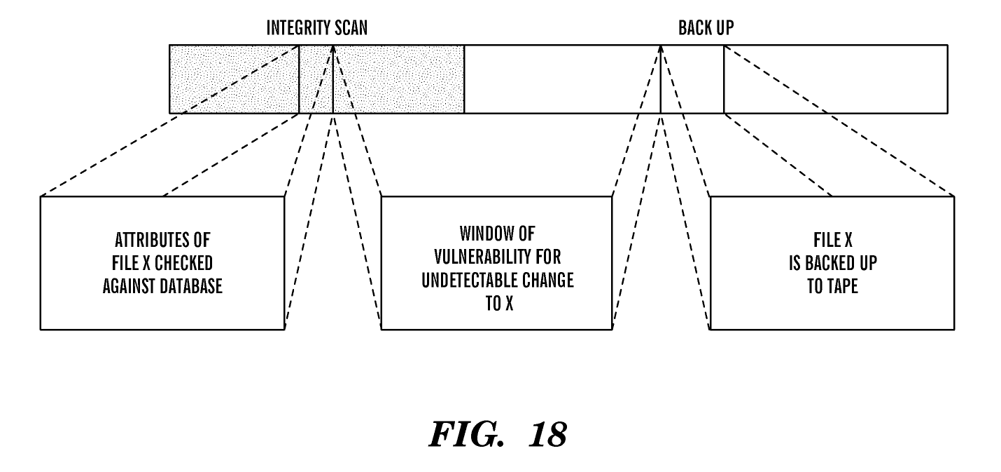

Now, consider the typical response to an intrusion. One common response is to reinstall the systems software and restore the system from the last trusted backup. But this begs the question, how can we establish trust in a backup. Suppose that an administrator were to run a file system scan, determine that the state of the file system was fine and then run a backup. There would be a window of vulnerability between the time that the scan of the file and when the file is backed up as seen in FIG. 18.

As we can see in FIG. 18, running the scan immediately after the backup, there will be some window of opportunity between when a file is scanned and when it is backed up due to the use of a multi-pass model.

Consider an intruder gaining access to a system (or an insider threat from a systems administrator), where the intruder knows when file system scans are scheduled. The intruder could install a backdoor after the scan but before the backup causing undetected contamination of the backup. If they forge the contents of a backed up copy of the integrity database, and trigger a data loss event, they could get a restore from the trusted but not trustworthy backup, installing the backdoor.

### 8.3 Client Side Trust Model

We assume that the client interacts with the broker and archives with insecure channels. For large institutional clients, distributing trust may be desirable to hold individuals accountable for their actions and limit the potential damage done by a small number of defectors. We divide the client into the following entities:
1. The backup agent is responsible for generating the plaintext of the archival data, signing the archival data message, authenticating the origin, generating a nonce session key for symmetric key encryption, and securely delivering the optionally encrypted archival data to the communication agent. The backup agent is assumed to be trusted to not divulge the plaintext, the nonce session key, k_{di,j}, and its public key, private key CBK⁻¹, CBK. As CBK is intended to identify who generated the archived data, CBK is used only for signing messages, and may be used across many different archived data sets. Since there may be many backup agents in our system, the client cᵢ's backup agent for the jth archived data object's public key, private key pair is denoted CBK_{i,j}⁻¹, CBK_{i,j} respectively.
2. Communications agents are responsible for forwarding the archival data from the backup agent to the broker, administering data already archived, retrieving the data from the broker (or in the event of broker failure, directly from the archives), and verifying the backup agent's signature and forwarding it to the restore agent in the event of a restore. The communication agent may optionally do the following: participate in data redistribution, and perform integrity testing using the challenge-response protocol of Section 6.3.2. Note that if the backup agent encrypts the data, the communication agent is never privy to the plaintext.
3. The restore agent is responsible for creating a nonce public/private key pair, CCK_{i,j}⁻¹ and CCK_{i,j}, the public key of which is supplied to the backup and communication agents. Additionally, the restore agent optionally verifies the correctness of the archived data, and signs the archived data object d_{i,j}, where d_{i,j}=<<<i, j, CBK_{i,j}^{˜1}, {k_{di,j}}_{CRKi,j}^{˜1}, {p_{i,j}}_{kdi,j}>_{CBKi,j}>_{CRKi,j}>_{CCKi,j}.
   At restore time, the restore agent receives d_{i,j} from the communications agent and verifies the signatures in d_{i,j} (double checking the communication agent's previous verification). If d_{i,j} is encrypted, the restore agent decrypts d_{i,j}. Thus, for encrypted archival data, the restore agent is trusted to conceal both the private restore key and the plaintext representation of the data.

We assume that the client interacts with the broker and archives with insecure channels. For large institutional clients, distributing trust may be desirable to hold individuals accountable for their actions and limit the potential damage done by a small number of defectors. We divide the client into the following entities.
1. Backup agent. This agent is responsible for signing the backup message, authenticating the origin, generating a nonce session key for symmetric key encryption, and securely delivering that to the broker.
   having a static pair of a public key k_{BackupAgent}⁼¹ and k_{BackMpAgent}
   supplying the plain text d_{i,j} is built from and the corresponding manifest L_{i,j}.
   obtaining the restore agent's public key for this particular backup, r_{i,j}⁻.
   computing a randomly generated nonce session key k_{di,j} for the backup.
   Generating the signed message, d_{i,j}<i, j,{k_{di,j}}_{n,j}⁻¹{d_{i,j}, <L_{i,j}>_{kB}}_{kdi,j}>_{kB}, which is sent to the broker over an insecure, but reliable channel,
The backup agent is assumed to be trusted to not divulge the plaintext, the nonce session key, k_{di,j}, and its private key k_{B}.
2. Restore Keyholders. These entities hold the shares for the private key necessary for the decryption of the symmetric key. The initial shares will be computed using a distributed key generation approach, i.e. like that of Gennaro, et al. We assume a mobile adversary capable of compromising at most t−1 participants out of a set of n=|P| participants in a Δ_{τ} time units duration. We also need to support changing the access structure to reflect changes in employees, etc., so that Γ^{(n,t)}_{P} with the original set of participants and threshold can be redistributed to a new access structure Γ^{n′,t′}_{P′}, where P′ is the new set of n′ participants, with a new threshold t′. We support this by proactively recutting the shares using Desmedt and Jajodia's verifiable secret redistribution protocol. For this we assume a secure broadcast channel and point-to-point channels between all keyholders. Correctly operating key holders are trusted to securely delete revoked shares (e.g. after redistribution), and to not leak their secret shares. Furthermore we assume that share holders have secure pairwise point to point and broadcast channels.
3. Communications Keyholders. These agents hold the shares for the private key used sign messages intended for the archive sites. We make similar assumptions to the restore agents, and thus this approach uses similar cryptographic approaches.
4. Restore agent. This is the trusted combiner of the Restore Keyholder's share. This agent restores the backup using the symmetric key decrypted using the private key contained in the shares. The restore agent is assumed to have a secure broadcast and point to point channel to each Restore key holder. The restore agent is trusted to conceal both the secret key, the shares used to construct the key and the plaintext representation of the backed up data.

### 8.4 Ensuring Authentication and Confidentiality Using Encryption

Confidentiality of data maintained in backups is critical, as backup tapes containing sensitive data can be lost or stolen. We have developed an approach that ensures confidentiality of backup tapes, by treating them as an insecure channel. Menezes, et al. consider digital signatures with message recovery, which can be implemented in our framework with public key cryptography as follows.

### 8.4.1 Creating a Backup

We treat the party making the backup as the sender and the party doing the recovery as the receiver. Let S, S⁻¹ denote the private and public keys of the sender and R, R⁻¹ denote the receiver's public and private keys. Also let the plain text of the backup be represented as a message, M, and the ciphertext be represented as C. To create a backup, the sender encrypts the raw data, M, as follows C={{M}_{S}}_{R}⁻¹. To recover from an encrypted backup, the receiver decrypts the data as follows M={{C}_{R}}_{S}⁻¹ We note that the encryption using the sender's private key encryption serves as a digital signature authenticating that the ciphertext was actually generated by the sender and not forged by another party. The encryption using the receiver's public key ensures confidentiality, and prevents people other than the receiver from reading the message (this step alone would have been sufficient to prevent the enormous loss of confidential data in).

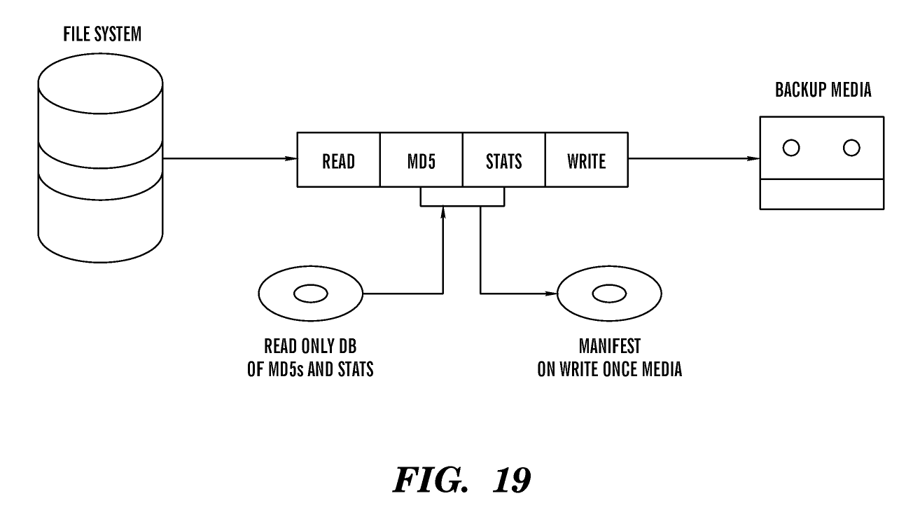

We seek to close this window of opportunity by using a pipelined approach, following the motto that one should eliminate gaps between the time of test and the time of use. In developing our approach, we noted that write speeds and capacity of the current generation of optical media (CDs and DVDs) is don't support enterprise level backups, and tape drives are used for high capacity backup solutions. However, many systems are configured with both, CD or DVD writers. Thus we assume that during the backup, it is possible to record statistical information (stats) about what got backed up on write once media (e.g. a CD) in addition to logging it in a file called the manifest. Information from past manifests can be incorporated into a database (DB), used for tracking when and how each backed up file changes, which can be then used to optionally perform integrity checking of files during the backup process as shown in FIG. 19.

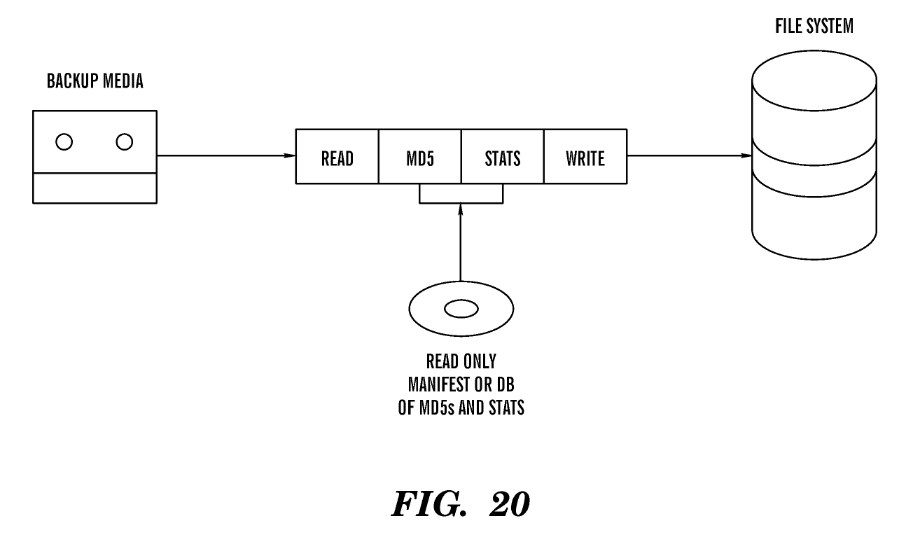

We note that it is possible that if the entity providing the backup tapes is not trustworthy, then restoring is risky. For large organizations or when the exposure is sufficiently large, it may make sense to separate the responsibility of backup and restore to limit risk exposure. Thus, we suggest keeping the manifests in escrow or storing the stats DB in a trusted locally attached network machine. The restore is the complementary process to the backup and is also pipelined. A restore can either use a database on read only media (or accessed over a trusted network connection) or the manifest with both, CD or DVD writers. Thus we assume that during the restore, it is possible to read the manifest from write once media (e.g. a CD), or use read only access to query the stats DB, as shown in FIG. 20.

### 8.5 Key Management for Data Recovery

We use key management as a mechanism for enforcing trust decisions. Thus, we were motivated to define the following system requirements.
1. The backup agent should be uniquely identified (authentication).
2. The plaintext representation of the backup should not be readable by unauthorized parties (confidentiality).
3. The authorized agents should be able to recover the plaintext of the backup given the ciphertext (availability).
4. For large organizations with dynamic trust, consensus should be required among an authorized subset of restore agents to read the backup's plaintext.
5. It should be possible to enforce document destruction by making it hard to recover the plaintext after the destruction decision has been made (Hippocratic confidentiality).

In a business environment, it is common for an employee trusted with recovering sensitive data to become unavailable or to leave the organization. Additionally, businesses need to manage risk exposures to a potential defector who wants to leak the backed up data. In larger organizations or for sufficiently large risk exposures, distributing trust may be in order, which indicates a secret sharing approach which requires consensus among trusted participants to access the shared secret. Additionally, revocation of individual trust, validation of initial shares and verifiable key redistribution are required when trust evolves over time. Finally, in some cases it may be useful to prevent a faulty (unfaithful) shareholder from submitting a false share in an attempt to prevent reconstruction of the secret. Due to the nature of the backup as a data communication channel, the key distribution will occur out-of-band.

### 8.5.1 Cryptographic Blocks for Key Management

We use the following notation in our key management approach.
Definition 1 Monotone Set A set S is monotone if it satisfies the property that if s∈S and s⊂s′ then s′∈S.
Informally, a monotone set is a set of subsets, such that if a subset is in a monotone set, then all of its supersets are also in the set.
To distribute trust for confidentiality, we will employ secret sharing.
Definition 2 [Secret Sharing Scheme] A secret sharing scheme given:
1. a secret, denoted S, S∈Zₚ,
2. a set of a set of n participants, P={p₁, p₂, . . . , pₙ},
3. an access structure denoted Γ, which is a monotone collection of qualified subsets (also called authorized subsets) Γ⊂2^{P}. If γ is a qualified subset then γ∈Γ.
   securely distributes the secret, S, among n participants, P={p₁, p₂, . . . , pₙ}, Secret sharing operates in two phases.
1. Share—Often assumes that a trusted entity, the dealer computes a set of n shares of S, denoted {s₁, s₂, . . . , sₙ}, and securely distributes share sᵢ to pᵢ over a private channel. Some forms of secret sharing use distributed key generation to eliminate the need for a dealer.
2. Reconstruct—A subset of the participants, denoted [P′], [P′]⊂P presents shares. If [P′]∈A and all the members of [P′] produce valid shares, the secret, S, can easily be recovered and securely distributed to members of [P′], otherwise the secret should not be revealed.
   Definition 3 [(t,n) threshold cryptography scheme with Access Structure Γ_{P}^{(t+1,n)}]A(t,n) threshold cryptography scheme is a secret sharing scheme given:
1. a set of n participants, denoted P and
2. a threshold t, t<n,
   where a subset of the participants, [P′]⊂P, is a qualified subset iff|[P′]|>t.
1. The corresponding access structure is denoted Γ_{P}^{(t+1,n)}.
   Definition 4 [Verifiable Secret Sharing (VSS)] A verifiable secret sharing scheme has an operation verify for which:

_{∃}u_{∀}[P′]∈Γ:(_{∀}i:pᵢ∈[P′]: verify(sᵢ) implies
(reconstruct({sᵢ|pᵢ∈[P′])=uΛu=s if the dealer is honest)
   Definition 5 [Non-interactive verification schemes] A non-interactive verification scheme is a verifiable secret sharing scheme with a verify algorithm that does not require interaction between the participants.
   Definition 6 [Perfect (t,n) threshold cryptography schemes] A perfect (t,n) threshold cryptography scheme provides no additional information about the secret S if fewer than t valid shares are provided in the reconstruct phase.
   Proactive secret sharing schemes redistribute key shares periodically to make it unlikely that a mobile adversary can reconstruct the entire key from its shares, by forcing the shares to periodically expire.

### 8.5.2 Overview of Our Key Management Approach

Our approach uses a proactive threshold key system with key redistribution, and assumes that the discrete log problem is hard. The following stages are used in the protocol:
1. Distributed key and initial share generation of the restore key, as seen in Section 8.5.3.
2. Verifiable threshold key secret sharing.
3. Verifiable share redistribution, as described in Section 8.5.4.
4. A consensus based key destruction approach in Section 8.5.6.

### 8.5.3 Distributed Key and Initial Share Generation

Distributed key generation (DKG) is a critical initial step in ensuring confidentiality of the private key shares in threshold cryptography schemes. DKG schemes should obey the correctness conditions as suggested by Pedersen and presented by Gennaro, et al.
1. All subsets of shares from t honest players define the same secret key, x.
2. All honest players have the same public key y=g^{x} mod q where x is the secret key from (C1).
3. x is uniformly distributed in Z_{q} (and hence uniformly distributed in the subgroup generated by g).

For robustness, Gennaro, et al. assume that n=2t−1 and tolerate at most \tilde{t}1 faults, and formulate a revised version of condition 8.5.3.
1. There is an efficient procedure that, given the shares produced by the n participants in the DKG protocol that computes the secret key, x, from the shares presented, even if up to t−1 of the players are faulty and submit false shares.

Pedersen proposed discrete log based method which Gennaro, et al. demonstrated could have bias introduced in the public key by incorrect participants, thus violating condition 8.5.3. Therefore for a discrete log based system, we recommend the state of the art approach by Gennaro, et al., for distributed key generation.

### 8.5.4 Verifiable Share Redistribution

Recall that in large organizations, we wish to employ a (t,n) threshold cryptography scheme to require consensus on signing and encrypting messages (the client communication key, CCK_{i,j}) and for restoring from an encrypted backup (the client restore key, CRK_{i,j}). However, persistence of the ciphertext makes key management challenging in the following ways.
1. Shares should be verifiable by participants, preferably in a noninteractive way.
2. Over time, a mobile adversary could gain control over t of n participants in the secret sharing scheme.
3. The set of participants is likely to evolve over time as people change positions within organizations or leave organizations and new participants may be recruited.

Proactive secret sharing is an open, yet heavily researched area which uses frequent recomputation of shares in secret sharing schemes (with secure deletion of old shares) to prevent mobile adversaries from acquiring t shares when an access structure, Γ_{P}^{(t,n)}, is used. Verifiable share redistribution is more flexible in that it allows for changing the set of n participants, from P to n′ participants, P′, and adjust the threshold from t to t′, i.e. the access structure Fp(t,n) can be changed to Γ_{P′}(t′,n′). Desmedt and Jajodia developed a verifiable share redistribution approach that meets our criteria, which would suitable for our purposes, in particular if we use discrete log based approaches, Wong and Wing's variant discussed is used in our initial implementation.

### 8.5.5 Distributed Digital Signature Schemes

Digital signatures are tools for authenticating and certifying the integrity of messages, and are heavily used in our protocols. In the presence of secret sharing, the computation of the signature would require consensus of the share holders, and ideally should be done without revealing the private key. Schnorr has created a very elegant digital signature scheme, which Genarro, et al. have extended to create a distributed digital signature protocol using the discrete log problem.

### 8.5.6 Consensus Based Key Destruction

For some applications data is constrained to have a limited storage duration due to legal and ethical confidentiality constraints of archived information. One way to do this is to revoke access to the key upon expiration. Our archival system has support for this by secure consensus based key destruction, since although secure deletion of archived data is not guaranteed, the archived data will be encrypted, and resistant to attack. Our method assumes that share holders can securely delete their shares and that no more than d=n−t<[n/2] (i.e. t>[n/2]) of the share holders are compromised. The protocol works as follows.
1. Using the distributed signature protocol, described in Section 8.5.5, the client share holders sign a message, denoted m in this protocol, of the form: m=<ClientDestroyKey, x, i, j>_{y} where (x,y) {(CCK, CCK_{i,j}), (CRKCRK_{i,j})}
2. If m is successfully created (and signed) then broadcast m to all key holders over a secure channel, otherwise abort.
3. Upon receipt of m all correct key holders securely delete their shares.

The correctness of this protocol follows from the correctness of the distributed signature protocol, which is robust in the presence of less than d<[n/2] defectors. The correct nodes, can accept the signed message as proof of a consensus among at least t=n−d>[n/2] correct share holders. When the correct share holders securely delete their keys, there will be at most d shares remaining, which means fewer than t>[n/2] shares will escape deletion, thereby making reconstruction of the secret (private key) impossible.

### 9 Distributing the Broker to Improve Capacity and to Strengthen Security

The model presented above in Section 7 is efficient, but can be improved in the following areas:
i) The broker's availability is limited due to it being a single point of failure (recall that availability is the ratio of the time a device working to the time the device is in use).
ii) Scalability of the broker is a bottle neck for data transmission.

We will consider two approaches, the first uses replication of brokers (i.e. hot spares) the second is our novel approach to distribute the broker).

### 9.1 Replicated State Machine Approach (Hot Spares)

Since we carefully designed our system using finite state machines, it can be shown that the broker can be implemented using replicated state machines (i.e. we can have hot spares of the broker). The key challenge in such an approach is to ensure consistency of the broker replicas, which implies detecting and recovering from some faulty replicas. In our model, only the client can detect failures of the replicas (via the challenge-response protocol described in Section 7.7), so broker faults are Byzantine (i.e. not immediately detectable). The classic approach to handling this is to use a Byzantine fault tolerant protocol using consensus of state machine replicas. A direct application of Byzantine fault tolerance protocols can work using a variant of an all-to-all 3 phase commit with a leader election protocol can detect and recover from a failure of at most ⅓ of the broker replicas. Such an approach allows us to directly address the availability issue but does not address the scalability issue, and in fact induces scalability problems since each consensus event requires O (N²) messages to be transmitted where N is the number of replicas, and our erasure encoded fragments are very large messages, so sending that many additional copies would overtax the network bandwidth which is the most limited and expensive resource in our system, and thus is contraindicated.

### 9.2 Our Distributed Broker Approach

In addition to bandwidth constraints, the storage capacity of a single broker limits our scalability. Thus we will extend the architecture of our system as seen in FIG. 20, where the broker B is represented by a set of broker agents, B={B₁, B₂, . . . , B_{N}}.

In this section, we discuss modifications of the protocols described in Section 7 that support the following:
1) Improved data availability in the presence of intermittent faults of network connections or broker nodes
2) Reduced network delays due to internal contention (although the final hop's speed is not affected).
3) Strengthened security of the broker, since the failure of a reasonably small (i.e. ┌N/3┐) will not compromise the integrity of the broker.
   This approach requires modifying the client and the broker as follows.
1) Each broker agent Bₓ in B has a public key k_{Bx} that is published and is made available to the client and the archives. The broker also has a public key k_{B} that can be computed for distributed signatures when needed.
2) Each broker agent will keep a challenge response list of at least ┌4 N C_{i,j,k}/3┐, where C_{i,j,k}=┌τ_{i,j}/Δt_{i,j,k}┐ is the number of challenge-response intervals. The reason for the 4/3 coefficient is to ensure sufficient challenges and responses are available on-line in the event of up to N/3 brokers failing.
3) Each broker agent will initially be assigned n_{i,j}/Nfragments to manage, and there will be an additional mapping of fragments to brokers that “own” them. To reduce overhead, fragments will only distributed from the client to the broker agent owning the fragment. The client will supply each non-owning broker agent a confidential challenge-response list to allow challenging the owner before the fragment is sent to the archives and challenge the archives afterwards.
4) When a fragment is retrieved (e.g. for a restore request) the retrieval should be done by a non-owning broker agent (if any exists) and that agent can replace the client-supplied challenge response list with one of their own.

### 9.2.1 Challenge Response List Management

For each broker agent, Bₓ∈B, if Bₓ owns the fragment e_{i,j,k}, computes its own challenge-response structure for the fragments it distributes to archives, otherwise the client, Cᵢ will supply to Bₓ the challenge-response list denoted bfi_{,j,k,x}=<i, j, k, x, {k_{CRi,j,k,Bx,}}_{kBx}⁻¹, {CR_{i,j,k,Bx}}_{kCRi,j,k,Bx}>_{kY}, where K_{y} represents the public key of the creator of the message. Letting fb_{i,j,k}={Bₓ₁, Bₓ₂, . . . , Bₓₙ}⊂B denotes the set of broker agents that have computed their own challenge-response lists, then broker B sends the augmented message f_{i,j,k}=<cfijk, bfi_{j,k,B1}, bfi_{j,k,B2}, . . . , bfi_{j,k,BN}>

9.2.2 Changes Needed for Client-Broker Storage ReservationThe client and broker need to agree on a mapping of which fragments are going to which brokers, which we will denote as FB_{i,j}, and (if this optimization is employed for conserving bandwidth, for more details see Section 9.2.4) which fragments will be delivered to the broker and which will be reconstructed by the broker, which we will denote as RB_{i,j}. The following extensions are required in the protocol to support this.
1) Just before sending the grant message to the client, the broker must establish consensus on FB_{i,j} and RB_{i,j}.
2) The grant message should be extended to contain the fields FB_{i,j} and RB_{i,j}.

9.2.3 Changes Needed for Initial Dissemination

We define a client initiated protocol, that supports distribution of a data object, d_{i,j}, via a distributed broker, B={B₁, B₂, . . . , B_{NB}} to a set of archives Aᵢⱼ(t)⊂A (t), and disseminates the erasure encoded representation of d_{i,j}, computes both an associated fragment to broker agent mapping, FB_{i,j}(t) and an associated fragment to archive mapping FA_{i,j}(t).
The protocol proceeds as follows:
1) The client and broker negotiate for encoding and storage parameters, including the reconstruction threshold, T_{i,j} and the fragment to broker mapping, FB_{i,j}, via the protocol defined in Section 9.2.2, and stores the grant message for the reserved storage for d_{i,j}.
2) The client, receives the grant message from B as per Step 1), and extracts the storage reservation message, the agreed erasure encoding parameters and the fragment to broker archive mapping, FB_{i,j}. Given d_{i,j} and the encoding parameters, the client computes the erasure encoding of d_{i,j}, denoted, e_{i,j,k}, and sends each broker agent, Bₓ∈B the following message:
   a) if Bₓ∈fb_{i,j,k}, Cᵢ sends the following message, which we will denote as C_{i,j,k,x} for the remainder of this section where, C_{i,j,k,x}=<ClientSendData, i, j, k, n_{i,j}, G_{i,j}, <cf_{i,j,k,x}>_{CCKi,j}>_{CCKij}, from which Bₓ extracts cf_{i,j,k,x} and uses concatenation to form f_{i,j,k}.

b) otherwise Bₓ∉fb_{i,j,k}. For notational convenience we describe a “verification” part of the summary message, used later in the protocol to check for correct archival, denoted for the remainder of this section as: V_{i,j,k,x}=<CR_{i,j,k,BX}>_{CCKi,j}. Client Cᵢ sends the corresponding summary message, which we will denote as S_{i,j,k,x}=<ClientSendSummaryDataTag, i, j, k, n_{i,j}, G_{i,j}, <s_{i,j,k}>_{CCKi,j}, {k_{Cri,j,k,Bx}}_{kBx}, {V_{i,j,x}}_{kCRi,j,k,Bx}>_{CCKi,j}, for the remainder of this section.
3) Each broker agent, Bₓ, will estimate a dual of fb_{i,j,k}, describing the set of full information fragments Bₓ will receive, for the duration of this section, we will refer to that set as scheduled_{i,j,k,x}={k|(1≦k≦n_{i,j})Λ(B_{x∈}fb_{i,j,k})}. Each broker agent will process the following messages based on scheduled_{i,j,k,x}.
   a) For all k∈scheduled_{i,j,k,x}, Bₓ will expect to receive the message C_{i,j,k,x} as defined in Step 2a), and one of the following cases happens:
      i) Bₓ receives the message and does the following:
         (1) Computes its own challenge-response list for the kth Fragment.
         (2) Performs the many fragments to any invited archive distribution, and records the set of messages indicating successful archival storage, denoted ArchiveStoreSuccessMSGSet_{i,j,k,x}.
      ii) Otherwise, the client times-out on message delivery and Bₓ complains by broadcasting <BrokerClientSendDataTimeout, i, j, k, n_{i,j}, G_{i,j}>_{kBX} to B and Cᵢ.
   b) If k∉scheduled_{i,j,k,x} then Bₓ expects to receive the summary message S_{i,j,k,x}, and does the following:
      i) Bₓ receives S_{i,j,k,x}, and does the following:
         (1) Each B_{y}∈fb_{i,j,k} will report to all Bₓ∉fb_{i,j,k} which archives it has sent f_{i,j,k} to, we will denote this as fa_{i,j,k,y}, and will send a message we will denote for the rest of this section as N_{i,j,k,y}=<BrokerAgentArchivesSelected, i, j, k, y, f_{i,j,k,y}>_{By}. Bₓ will use this to refine its estimate of fa_{i,j,k}, denoted fa_{i,j,k,x}.
         (2) For each aₓ∈fa_{i,j,k}, By will challenge aₓ using the challenge-response protocol.
      ii) Otherwise, Bₓ times out waiting for S_{i,j,k,x} and then Bₓ broadcasts <BrokerClientSendSummaryDataTimeout, i,j,k,n_{i,j},G_{i,j}>_{Bx} to B and Cᵢ
   c) B will attempt to establish consensus on estimating FB_{i,j} and FA_{i,j} using Byzantine consensus using witnesses of correct archival, which are
      i) if Bₓ∈fb_{i,j,k}, then Bₓ presents ArchiveStoreSuccessMSGSet_{i,j,k,x}.
      ii) otherwise, Bₓ∉fb_{i,j,k}, Bₓ should present the Challenge-Response outcomes for archives in fa_{i,j,k,x}.
   d) Global estimates for fa_{i,j,k} and fb_{i,j,k} can be achieved by set intersection of the local estimators, fa_{i,j,k,x} and fb_{i,j,k,x}, verified by the witnesses computed in Step 3c). Any proven misbehavior will result in an archive being removed from fa_{i,j,k} and a broker's removal from fb_{i,j,k} respectively. Based on the outcome the following can occur:
      i) If n_{i,j}≧NonEmptyMapCount(FA_{i,j})>T_{i,j} then sufficient fragments have been distributed, and reconstruction is not triggered and the operation succeeds.
         (1) B sends Cᵢ the message we will denote for the purposes of this section as B_{i,j}, containing ArchiveStoreSuccessMSGSet_{i,j} defined in Section 7.6, where B_{i,j}=<BrokerStoreSuccess, G_{i,j}, |ArchiveStoreSuccessMSGSet_{i,j}|, ArchiveStoreSuccessMSGSet_{i,j}>_{kB}.
         (2) The broker sends each archive, Aₓ∈fa_{i,j,k}, 1≦k≦n_{i,j} the message <BrokerStoreCommit, S_{i,j,k,x}>_{kB}, where S_{i,j,k,x}∈ArchiveStoreSuccessMessage_{i,j}. A correct archive will reply to this message with <ArchiveAckStoreCommit, B_{i,j}>_{kAx}.
      ii) If T_{i,j}>NonEmptyMapCount(FA_{i,j}) then the number of fragments successfully distributed has fallen below the reconstruction threshold, and the following occurs.
         (1) B sends the client <BrokerStoreFailed, i, j, k, n_{i,j}, m_{i,j}, t_{i,j}, τ_{i,j}>_{kB} B sends each archive Aₓ∈fa_{i,j,k}, 1≦k≦n_{i,j} an abort message allowing them to reclaim their resources, <BrokerStoreAbort, i, A, k, n_{i,j}, m_{i,j}, t_{i,j}, τ_{i,j}>_{kB}. 9.2.4 Changes Needed Recovery of the Data object.

Given a mapping of which fragments are “owned” by which brokers, denoted FB_{i,j}, reconstruction of the data object proceeds as follows:
1) The client, Cᵢ, sends a request to some Bₓ in the set of broker agents.
2) Via Byzantine fault tolerant methods the agents determine a subset of FB_{i,j} denoted RB_{i,j} which will map fragments to the agents who will deliver them. This mapping should be chosen to maximize the number of fragments an individual broker has retrieved, subject to any bandwidth and jurisdictional constrains, thereby enabling agents to generate challenge-response lists, without having to pay for a separate retrieval operation
3) RB_{i,j} is sent to Cᵢ, and for each (Bₓ, f_{i,j,k}) tuple in in RB_{i,j} c will expect to receive f_{i,j,k} from Bₓ.
4) If any fragment is not delivered, c will notify a Bₓ other than the agent that has not delivered the fragments, and via BFT, the agents will send an updated mapping to Cᵢ.
5) Upon receipt of all fragments, Cᵢ will verify its signatures, and erasure decodes the data object.

What is claimed is:

1. An infrastructure for archiving data among a client, a broker, and a plurality of archives, wherein the client comprises:
a backup agent configured to fragment and erasure encode the data to create a set of erasure encoded data fragments;
a communications agent configured to communicate the erasure encoded data fragments to the broker, issue a challenge for a challenge/response protocol to the broker, and to request data from the archives; and
a restore agent configured to combine the data fragments obtained from the broker upon a data restore request.

2. The infrastructure of claim 1, wherein the backup agent is further configured to compress and encrypt the data.

3. The infrastructure of claim 2, wherein the restore agent is further configured to decode, decompress and decrypt the data.

4. The infrastructure of claim 1, further comprising a plurality of brokers.

5. The infrastructure of claim 1, further comprising a key redistribution system.

6. The infrastructure of claim 1, further comprising a loss probability system.

7. A method for archiving data among a client, a broker, and a plurality of archives, comprising:
fragmenting and erasure encoding the data at a client to create a set of erasure encoded data fragments;
communicating the set of erasure encoded data fragments to the broker; and
storing the set of erasure encoded data fragments in a plurality of archives.

8. The method of claim 7, further comprising:
transmitting a request for the data from the client to the broker;
recalling the set of erasure encoded data fragments from the plurality of archives;
transmitting the set of erasure encoded data fragments back to the client; and
restoring the data from the set of erasure encoded data fragments at the client.

9. The method of claim 8, wherein the set of erasure encoded data fragments are compressed and encrypted by the client.

10. The method of claim 9, wherein the restoring includes decoding, decompressing and decrypting the set of erasure encoded data fragments.

11. The method of claim 8, wherein the set of erasure encoded data fragments is transmitted to a plurality of brokers.

12. The method of claim 10, wherein a key redistribution system is utilized prevent any single user from restoring the data, wherein the key redistribution system includes providing a first encryption key for reading the data, and a second encryption key for administering the data.

13. The method of claim 12, further comprising sharing shares of encryption keys within an organization using a verifiable secret sharing method.

14. The method of claim 13, further comprising:
redistributing the shares in response to a suspicion of a shareholder or a change in organizational structure; and
destroying at least one share to revoke access.

15. A computer readable storage medium having a computer program product stored thereon for archiving data among a client, a broker, and a plurality of archives, which when executed by a computer system comprises:
program code configured to fragment and erasure encode the data to create a set of erasure encoded data fragments;
program code configured to communicate the erasure encoded data fragments to the broker, issue a challenge for a challenge/response protocol to the broker, and to request data from the archives; and
program code configured to restored the data by combining the data fragments obtained from a broker upon a data restore request.

16. The computer readable storage medium of claim 15, further comprising program code configured to compress and encrypt the data.

17. The computer readable storage medium of claim 16, further comprising program code configured to decode, decompress and decrypt the data.

18. The computer readable storage medium of claim 15, further comprising program code configured to redistribute encryption keys to ensure that a single user cannot restored the data.

19. The computer readable storage medium of claim 15, further comprising program code configured to calculate a loss probability.
